(19) United States
(12) Patent Application Publication
(10) Pub. No.: US 2026/0179541 A1
(43) Pub. Date: Jun. 25, 2026

(54) GATE DRIVER CIRCUIT, DISPLAY PANEL, AND DISPLAY DEVICE

(71) Applicant: Wuhan Tianma Microelectronics Co., Ltd., Wuhan (CN)

(72) Inventor: Wenshuai ZHANG, Wuhan (CN)

(73) Assignee: Wuhan Tianma Microelectronics Co., Ltd., Wuhan (CN)

(21) Appl. No.: 19/420,663

(22) Filed: Dec. 15, 2025

(30) Foreign Application Priority Data
Dec. 23, 2024 (CN) 202411911895.4

(51) Int. Cl. G09G 3/32

(52) U.S. Cl. CPC G09G 3/32; G09G 2300/0819; G09G 2300/0842; G09G 2310/0286; G09G 2310/061; G09G 2310/08

(57) ABSTRACT

Provided are a gate driver circuit, a display panel, and a display device. A first driver circuit outputs a first node signal and a second node signal, a first output sub-circuit receives the first node signal and is electrically connected to a second clock signal terminal and a first output terminal, a second output sub-circuit receives the second node signal and is electrically connected to a second-level signal terminal and a first output terminal, the first output terminal provides a first control signal, a third output sub-circuit receives the first node signal and is electrically connected to a second-level signal terminal and a second output terminal, a fourth output sub-circuit receives a third node signal and is electrically connected to the first-level signal terminal and a second output terminal, the second output terminal provides a second control signal, and enable levels of the first and second control signals partially overlap.

### CROSS-REFERENCE TO RELATED APPLICATIONS

This application claims priority to Chinese Patent Application No. 202411911895.4, filed on December 23, 2024, which is hereby incorporated by reference in its entirety.

### TECHNICAL FIELD

The present disclosure relates to the technical field of display technology, and in particular to a gate driver circuit, a display panel, and a display device.

### BACKGROUND

To control the pixel driver circuit in the display panel, the gate driver circuit needs to be provided in the display panel to provide the control signal to the pixel driver circuit. Currently, the gate driver circuit has a complex structure and requires a large space in the display panel, limiting the narrow bezel design of the display panel.

### SUMMARY

In a first aspect, some embodiments of the present disclosure provide a gate driver circuit, which includes a first driver circuit, a first output circuit, and a second output circuit. The first driver circuit is connected to a first clock signal terminal, a first input signal terminal, and a first-level signal terminal, and is configured to output a first node signal of a first node and a second node signal of a second node based on a signal of the first clock signal terminal, a signal of the first input signal terminal, and a signal of the first-level signal terminal. The first output circuit includes a first output sub-circuit, a second output sub-circuit, and a first output terminal. The first output sub-circuit is configured to receive the first node signal and electrically connected to a second clock signal terminal and the first output terminal, the second output sub-circuit is configured to receive the second node signal and electrically connected to a second-level signal terminal and the first output terminal, and the first output terminal is configured to provide a first control signal. The second output circuit includes a third output sub-circuit, a fourth output sub-circuit, and a second output terminal. The third output sub-circuit is configured to receive the first node signal and electrically connected to the second-level signal terminal and the second output terminal, the fourth output sub-circuit is configured to receive a third node signal of a third node and electrically connected to the first-level signal terminal and the second output terminal, and the second output terminal is configured to provide a second control signal. An enable level of the first control signal at least partially overlaps with an enable level of the second control signal.

In a second aspect, some embodiments of the present disclosure provide a display panel, which includes a pixel driver circuit and the above gate driver circuit. The pixel driver circuit includes a driver transistor, a first pixel transistor electrically connected to a first electrode of the driver transistor and including a P-type transistor, and a second pixel transistor electrically connected to a gate of the driver transistor and including an N-type transistor. A gate of the first pixel transistor is configured to receive the first control signal, and a gate of the second pixel transistor is configured to receive the second control signal.

In a third aspect, some embodiments of the present disclosure provide a display device including the above display panel.

### BRIEF DESCRIPTION OF THE DRAWINGS

In order to more clearly illustrate the technical solutions of the embodiments of the present disclosure, the drawings to be used in the embodiments are briefly described below. Obviously, the drawings described below are only some embodiments of the present disclosure. For those skilled in the art, other drawings can be obtained based on these drawings without any creative effort.

FIG. 1 is a circuit diagram of a gate driver circuit provided by some embodiments of the present disclosure;

FIG. 2 is an operating timing diagram of the gate driver circuit shown in FIG. 1;

FIG. 3 is a schematic diagram showing a connection relationship between a pixel driver circuit and a light-emitting element provided by some embodiments of the present disclosure;

FIG. 4 is an operating timing diagram of the pixel driver circuit shown in FIG. 3;

FIG. 5 is another schematic diagram of a gate driver circuit provided by some embodiments of the present disclosure;

FIG. 6 is an operating timing diagram of the gate driver circuit shown in FIG. 5;

FIG. 7 is another schematic diagram of a gate driver circuit provided by some embodiments of the present disclosure;

FIG. 8 is a schematic diagram of a gate driver circuit provided by some embodiments of the present disclosure;

FIG. 9 is a schematic diagram of a gate driver circuit provided by some embodiments of the present disclosure;

FIG. 10 is an operating timing diagram of the gate driver circuit shown in FIG. 9;

FIG. 11 is another schematic diagram of a gate driver circuit provided by some embodiments of the present disclosure;

FIG. 12 is an operating timing diagram of the gate driver circuit shown in FIG. 11;

FIG. 13 is another schematic diagram of a gate driver circuit provided by some embodiments of the present disclosure;

FIG. 14 is an operating timing diagram of the gate driver circuit shown in FIG. 13;

FIG. 15 is another schematic diagram of a gate driver circuit provided by some embodiments of the present disclosure;

FIG. 16 is an operating timing diagram of the gate driver circuit shown in FIG. 15;

FIG. 17 is a schematic diagram of a shift register provided by some embodiments of the present disclosure;

FIG. 18 is a timing diagram of a frame start signal line, a first clock signal line, and a second clock signal line provided by some embodiments of the present disclosure;

FIG. 19 is a schematic diagram of a shift register provided by some embodiments of the present disclosure;

FIG. 20 is a timing diagram of a frame start signal line, a first clock signal line, a second clock signal line, a third clock signal line, and a fourth clock signal line provided by some embodiments of the present disclosure;

FIG. 21 is a schematic diagram of a display panel provided by some embodiments of the present disclosure;

FIG. 22 is another schematic diagram of a display panel provided by some embodiments of the present disclosure; and

FIG. 23 is a schematic diagram of a display device provided by some embodiments of the present disclosure.

### DETAILED DESCRIPTION

In order to better understand the technical solution of the present disclosure, the embodiments of the present disclosure are described in detail below with reference to the accompanying drawings.

It should be clear that the embodiments described are only a part of the embodiments of the present disclosure, not all of the embodiments. Based on the embodiments of the present disclosure, all other embodiments obtained by persons of ordinary skilled in the art without creative effort fall within the protection scope of the present disclosure.

The terms used in the embodiments of the present disclosure are only for describing specific embodiments and are not intended to limit the present disclosure. The singular forms "a", "an", and "the" used in the embodiments of the present disclosure and the appended claims are also intended to include plural forms unless the context clearly indicates otherwise.

It should be understood that the term "and/or" as used herein simply describes a relationship between associated objects, indicating that three possible relationships exist. For example, "A and/or B" can represent: A alone, A and B, or B alone. Furthermore, the character "/" in this document generally indicates an "or" relationship between the associated objects.

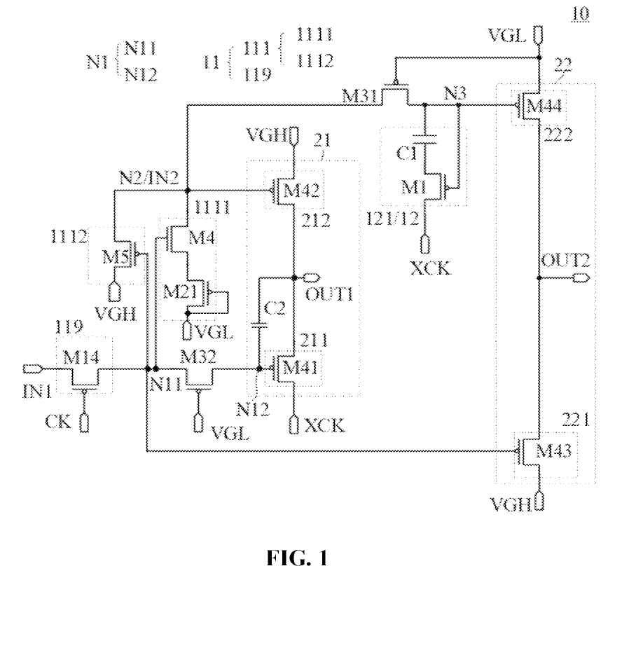

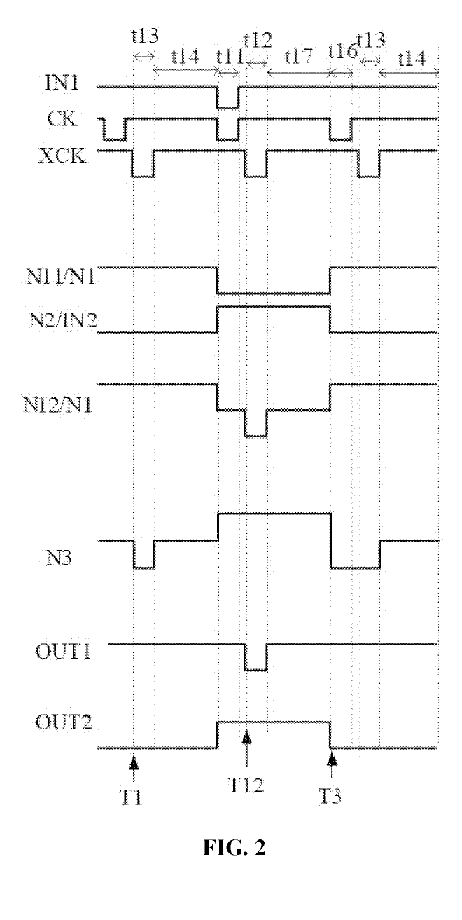

Some embodiment of the present disclosure provides a gate driver circuit, as shown in FIGS. 1 and 2. FIG. 1 is a circuit diagram of a gate driver circuit provided by some embodiments of the present disclosure, and FIG. 2 is an operating timing diagram of the gate driver circuit shown in FIG. 1. The gate driver circuit 10 includes a first driver circuit 11, a first output circuit 21, and a second output circuit 22.

The first driver circuit 11 is connected to a first clock signal terminal CK, a first input signal terminal IN1, and a first-level signal terminal VGL, and is configured to output a first node signal of the first node N1 and a second node signal of the second node N2 based on a signal of the first clock signal terminal CK, a signal of the first input signal terminal IN1, and a signal of the first-level signal terminal VGL.

The first output circuit 21 includes a first output sub-circuit 211, a second output sub-circuit 212, and a first output terminal OUT1. The first output sub-circuit 211 is configured to receive the first node signal and is electrically connected to a second clock signal terminal XCK and the first output terminal OUT1. The second output sub-circuit 212 is configured to receive the second node signal and is electrically connected to a second-level signal terminal VGH and the first output terminal OUT1. The first output terminal OUT1 is configured to provide a first control signal.

The second output circuit 22 includes a third output sub-circuit 221, a fourth output sub-circuit 222, and a second output terminal OUT2. The third output sub-circuit 221 is configured to receive the first node signal and is electrically connected to the second-level signal terminal VGH and the second output terminal OUT2. The fourth output sub-circuit 222 is configured to receive a third node signal of a third node N3 and is electrically connected to the first-level signal terminal VGL and the second output terminal OUT2. The second output terminal OUT2 is configured to provide a second control signal.

In the embodiments of the present disclosure, the signal provided by the first-level signal terminal VGL and the signal provided by the second-level signal terminal VGH are both constant signals. The first-level signal terminal VGL is configured to provide a first-level signal, and the second-level signal terminal VGH is configured to provide a second-level signal. A voltage value of the first-level signal is smaller than a voltage value of the second-level signal.

As shown in FIG. 2, the signal provided by the first clock signal terminal CK and the signal provided by the second clock signal terminal XCK are both pulse signals capable of switching between a first-level signal and a second-level signal. Furthermore, the signal provided by the first clock signal terminal CK and the signal provided by the second clock signal terminal XCK can be pulse signals with a phase difference.

Optionally, as shown in FIG. 2, the signal of the first clock signal terminal CK and the signal of the second clock signal terminal XCK are pulse signals with a same period. FIG. 2 illustrates that the periods of the signals of the first clock signal terminal CK and the second clock signal terminal XCK are equal to a pulse width of the enable level of the second control signal outputted by the second output terminal OUT2.

Exemplarily, a pulse width of the first-level signal provided by the first clock signal terminal CK can be smaller than or equal to a pulse width of the second-level signal provided by the first clock signal terminal CK. The pulse width of the first-level signal provided by the second clock signal terminal XCK can be smaller than or equal to a pulse width of the second-level signal provided by the second clock signal terminal XCK. FIG. 2 illustrates an example in which the pulse width of the first-level signal provided by the first clock signal terminal CK is smaller than the pulse width of the second-level signal provided by the first clock signal terminal CK, and the pulse width of the first-level signal provided by the second clock signal terminal XCK is smaller than a pulse width of the second-level signal provided by the second clock signal terminal XCK. Optionally, the pulse widths of the first-level signals provided by the first clock signal terminal CK and the second clock signal terminal XCK can be the same.

In the embodiments of the present disclosure, the enable level of the first control signal and the enable level of the second control signal have different potentials. For example, the enable level of the first control signal can be the first-level signal, and the enable level of the second control signal can be the second-level signal.

Furthermore, the enable level of the first control signal at least partially overlaps with the enable level of the second control signal. As shown in FIG. 2, the first output terminal OUT1 outputs the enable level of the first control signal during a second period t12, and the second output terminal OUT2 outputs the enable level of the second control signal during both a first period t11 and the second period t12.

In the embodiments of the present disclosure, the first control signal and the second control signal can be configured to control transistors with different channel types in the pixel driver circuit.

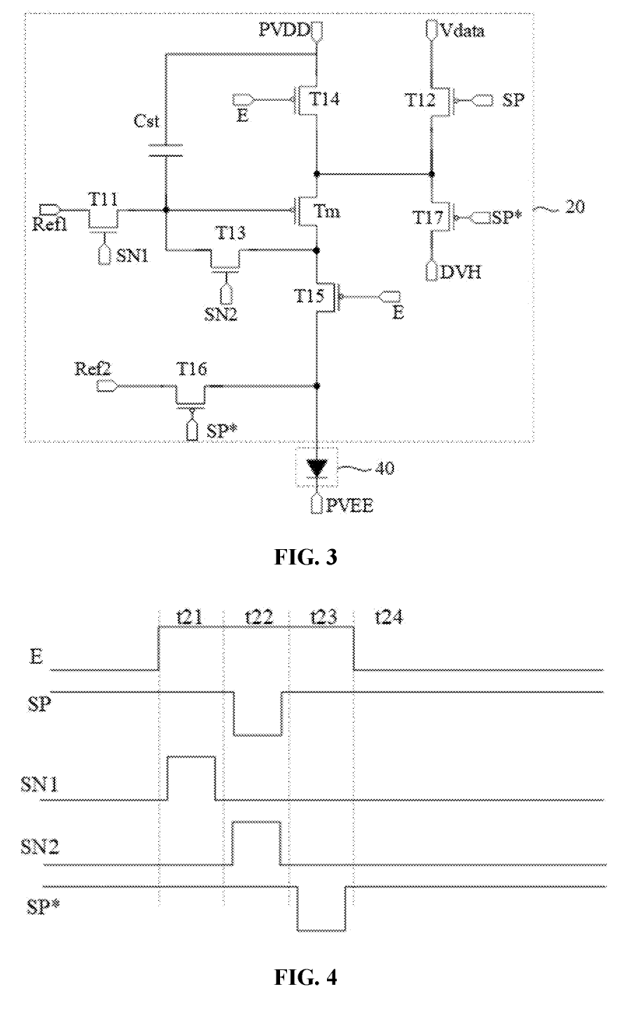

Optionally, in combination with FIGS. 3 and 4 in which FIG. 3 is a schematic diagram of the connection relationship between a pixel driver circuit and a light-emitting element provided in an embodiment of the present disclosure, and FIG. 4 is an operating timing diagram of the pixel driver circuit shown in FIG. 3, the pixel driver circuit 20 includes a storage capacitor Cst, a driver transistor Tm, a gate reset transistor T11, a data writing transistor T12, a threshold compensation transistor T13, a first light-emitting control transistor T14, a second light-emitting control transistor T15, an anode reset transistor T16, and a bias adjustment transistor T17.

Optionally, the threshold compensation transistor T13 and the gate reset transistor T11 that are electrically connected to a gate of the driver transistor Tm include N-type transistors, such as oxide transistors, to reduce leakage current at the gate of the driver transistor Tm and improve the stability of a gate potential of the driver transistor Tm. The data writing transistor T12 and the bias adjustment transistor T17 include P-type transistors, such as low-temperature polysilicon transistors.

When the pixel driver circuit 20 is operating, as shown in FIG. 4, the operating process of the pixel driver circuit 20 includes a gate reset period t21, a data writing period t22, a bias adjustment period t23, and a light-emitting period t24.

During the gate reset period t21, a first scan control terminal SN1 transmits an enable signal, the gate reset transistor T11 is turned on, and a first reset signal provided by the first reset signal terminal Ref1 resets the gate of the driver transistor Tm through the gate reset transistor T11.

During the data writing period t22, a second scan control terminal SP transmits an enable signal, the data writing transistor T12 is turned on, and a third scan control terminal SN2 transmits an enable signal, the threshold compensation transistor T13 is turned on, and the signal of the data signal terminal Vdata charges the gate of the driver transistor Tm through the driver transistor Tm and the threshold compensation transistor T13 until a potential Vg of the gate of the driver transistor Tm changes to Vg=Vdata-|Vth|, where Vth denotes a threshold voltage of the driver transistor Tm, thereby completing data writing and threshold compensation.

During the bias adjustment period t23, an adjustment control terminal SP* transmits an enable signal, and the bias adjustment transistor T17 and the anode reset transistor T16 are turned on. During this period, a bias adjustment signal provided by an adjustment signal terminal DVH is written to a first electrode of the driver transistor Tm via the bias adjustment transistor T17. A second reset signal provided by a second reset signal terminal Ref2 resets a light-emitting element 40 via the anode reset transistor T16.

During the light-emitting period t24, a light-emitting control signal terminal E transmits an enable signal, a first light-emitting control transistor T14 and a second light-emitting control transistor T15 are turned on. A first power supply voltage signal PVDD is written to the first electrode of the driver transistor Tm. A gate potential of the driver transistor Tm is maintained at Vg = Vdata - |Vth| by the storage capacitor Cst. A potential Vs of the first electrode of the driver transistor Tm satisfies Vs = V_{PVDD}, where V_{PVDD} denotes a potential of the first power supply voltage signal PVDD. The driver transistor Tm is turned on, and a current controlled by the gate potential of the driver transistor Tm flows through the light-emitting element 40 to light up the light-emitting element 40.

In the embodiments of the present disclosure, the first control signal output by the gate driver circuit 10 can be a signal for controlling a first pixel transistor in the pixel driver circuit 20 to be turned on, and the second control signal output by the gate driver circuit 10 can be a signal for controlling a second pixel transistor in the pixel driver circuit 20 to be turned on. The first pixel transistor includes a P-type transistor, which is turned off by a high-level control signal and turned on by a low-level control signal; the second pixel transistor includes an N-type transistor, which is turned on by a high-level control signal and turned off by a low-level control signal.

Optionally, the first pixel transistor includes the data writing transistor T12 in the pixel driver circuit shown in FIG. 3, and the second pixel transistor includes the threshold compensation transistor T13 or the gate reset transistor T11 in the pixel driver circuit shown in FIG. 3.

For example, a period during which the enable level of the first control signal overlaps with the enable level of the second control signal can be a period during which the pixel driver circuit 20 electrically connected to the gate driver circuit 10 is scanned. When the display panel is displaying an image, a plurality of pixel driver circuit rows in the display panel are scanned row by row in accordance with a scanning order of the display panel to perform operations such as writing data voltages and threshold compensation row by row. The period during which the pixel driver circuit 20 is scanned refers to a period during which the pixel driver circuit 20 is selected to perform operations such as writing data voltages and threshold compensation.

When the gate driver circuit 10 is operating, in combination with FIGS. 1 and 2, the operating process of the gate driver circuit 10 at least includes a first period t11 and a second period t12.

During the first period t11, the first clock signal terminal CK provides an enable level that is a signal capable of controlling the transistor whose gate is electrically connected to the first clock signal terminal CK in the gate driver circuit 10 to be turned on, and FIG. 2 illustrates that this enable level is the first-level signal; the first input signal terminal IN1 provides an enable level that is a signal capable of controlling a transistor whose gate is electrically connected to the first node N1 in the first output sub-circuit 211 to be turned on, and FIG. 2 illustrates that this enable level is the first-level signal, so that the first node signal at the first node N1 to be an enable level, i.e., the first-level signal, to control the first output sub-circuit 211 and the third output sub-circuit 221 to be turned on. During the first period t11, the second clock signal terminal XCK provides a second-level signal, which can be written to the first output terminal OUT1 via the turned on first output sub-circuit 211. The second-level signal provided by the second-level signal terminal VGH can be written to the second output terminal OUT2 via the turned on third output sub-circuit 221.

During the first period t21, the third node N3 is at a disable level capable of controlling the fourth output sub-circuit 222 to be turned off, and FIG. 2 illustrates that the disable level is the second-level signal.

During the second period t12, the first clock signal terminal CK provides a disable level that refers to a signal that can control a transistor whose gate is electrically connected to the first clock signal terminal CK in the gate driver circuit 10 to be turned off, and FIG. 2 illustrates that the disable level is the second-level signal; the second clock signal terminal XCK provides an enable level that refers to a level that can control the first pixel transistor electrically connected to the first output terminal OUT1 in the pixel driver circuit 20 to be turned on. The first pixel transistor includes the data writing transistor T12 in the pixel driver circuit 20 shown in FIG. 3, and FIG. 2 illustrates that the enable level is the first-level signal.

As shown in FIG. 2, during the second period t12, the first node signal of the first node N1 maintains the enable level. The first output sub-circuit 211 and the third output sub-circuit 221 are turned on under the control of the first node N1. The enable level provided by the second clock signal terminal XCK is written to the first output terminal OUT1 via the first output sub-circuit 221; the second-level signal provided by the second-level signal terminal VGH is written to the second output terminal OUT2 via the third output sub-circuit 221.

During the second period t12, the second node signal of the second node N2 is a disable level that refers to a level capable of controlling the second output sub-circuit 212 to be turned off, and FIG. 2 illustrates that the disable level is a high level.

During the second period t12, the third node signal of the third node N3 is a disable level that refers to a level capable of controlling the fourth output sub-circuit 222 to be turned off, and FIG. 2 illustrates that the disable level is a high level.

The gate driver circuit 10 provided by the embodiments of the present disclosure can output the first control signal through the first output terminal OUT1, and can output the second control signal through the second output terminal OUT2, and thus there is no need to provide two gate driver circuits 10 for the first control signal and the second control signal, respectively, which is beneficial to reducing the area of the gate driver circuit 10. When the gate driver circuit 10 is applied to a display panel, it is beneficial to reducing the area of the non-display region occupied by the gate driver circuit 10, thereby increasing the screen-to-body ratio of the display panel.

Optionally, the first control signal and the second control signal can be configured to control transistors of two different channel types in the pixel driver circuit 20 to be turned on or off.

Moreover, in the embodiments of the present disclosure, by electrically connecting both the first output sub-circuit 211 and the third output sub-circuit 221 to the first node N1, there is no need to set control nodes for the first output sub-circuit 211 and the third output sub-circuit 221, respectively, which can further simplify the structure of the gate driver circuit 10.

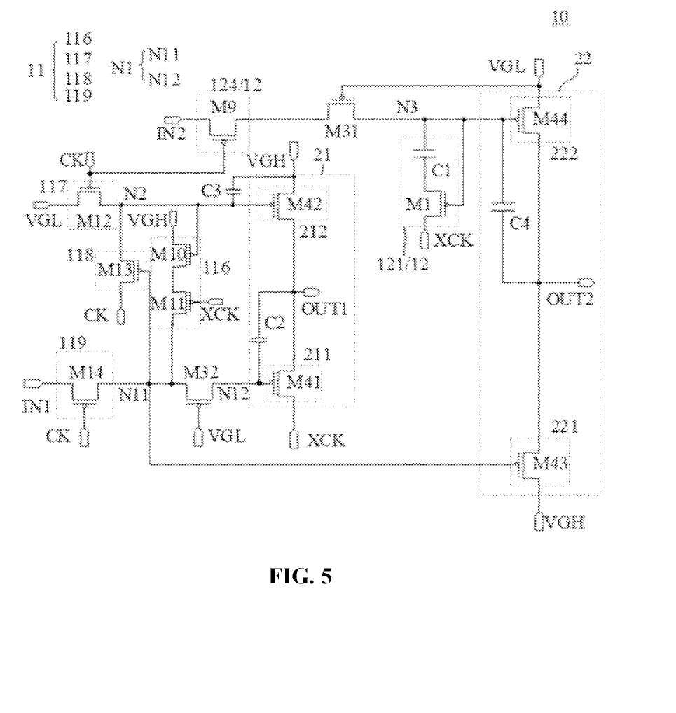

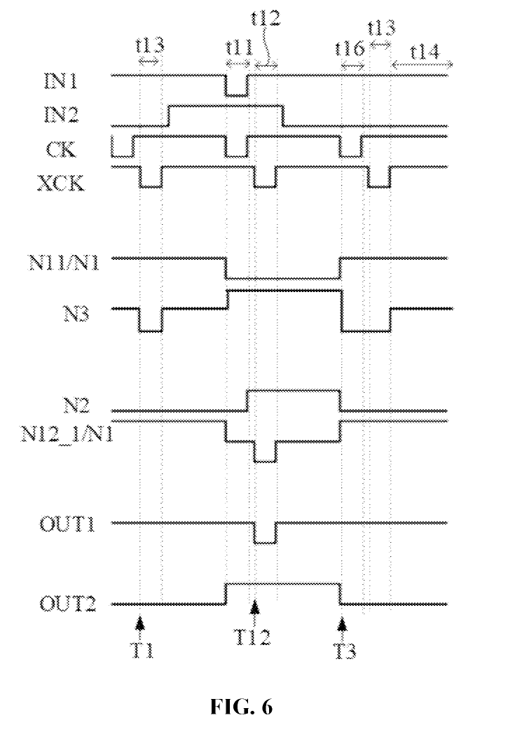

For example, as shown in FIGS. 1 and 5 in which FIG. 5 is another schematic diagram of a gate driver circuit provided in some embodiments of the present disclosure, the gate driver circuit 10 includes a second driver circuit 12 electrically connected to the second input signal terminal IN2 and the third node N3. The second input signal terminal IN2 is at least configured to provide a disable level to the third node signal of the third node N3 when the second control signal is an enable level, for example, at least during the second period t12 shown in FIGS. 2 and 6 in which FIG. 6 is an operating timing diagram of the gate driver circuit shown in FIG. 5. Under the action of this disable level, the fourth output sub-circuit 222 is turned off to prevent the first-level signal provided by the first-level signal terminal VGL from being written to the second output terminal OUT2 during the second period t12.

In some embodiments of the present disclosure, the second input signal terminal IN2 can be implemented in multiple ways. As shown in FIG. 1, in the embodiments of the present disclosure, the third node N3 can be electrically connected to the second node N2, that is, the second node N2 can be reused as the second input signal terminal IN2.

Alternatively, as shown in FIG. 5, in some embodiments of the present disclosure, the third node N3 can also be electrically connected to the second input signal terminal IN2 via a fifth writing unit 124. The specific operating process of the gate driver circuit 10 shown in FIGS. 1 and 5 will be described below and will not be repeated herein.

For example, as shown in FIGS. 1 and 5, the second driver circuit 12 includes a first adjustment unit 121, which is electrically connected to the third node N3 and the second clock signal terminal XCK, and which is configured to control the third node signal of the third node N3 based on the signal of the second clock signal terminal XCK. In some embodiments of the present disclosure, during at least one of the periods during which the second control signal is a disable level, the first adjustment unit 121 is configured to cause a voltage value of the third node signal of the third node N3 to be lower than a voltage value of the first-level signal of the first-level signal terminal VGL.

Optionally, with reference to FIGS. 2 and 6, the operating process of the gate driver circuit 10 includes a third period t13. During the third period t13, the first control signal output by the first output terminal OUT1 is a disable level, and the second control signal output by the second output terminal OUT2 is also a disable level. That is, the pixel driver circuit row electrically connected to the gate driver circuit 10 in the display panel is in a non-scanning period.

In some embodiments of the present disclosure, the first adjustment unit 121 is configured to cause the voltage value of the third node signal of the third node N3 to be lower than the voltage value of the first-level signal of the first-level signal terminal VGL during at least the third period t13, and the third node signal of the third node N3 during the third period t13 is defined as a third-level signal. In other words, a voltage value of the third-level signal is lower than the voltage value of the first-level signal. Under the action of the third-level signal, the fourth output sub-circuit 222 can be stably turned on, so that the low level provided by the first-level signal terminal VGL can be stably output to the second output terminal OUT2.

For example, as shown in FIGS. 1 and 5, the first adjustment unit 121 includes a first capacitor C1 and a first transistor M1. A gate of the first transistor M1 is electrically connected to the third node N3, a first electrode of the first transistor M1 is electrically connected to the second clock signal terminal XCK, and a second electrode of the first transistor M1 is electrically connected to a first plate of the first capacitor C1. A second plate of the first capacitor C1 is electrically connected to the third node N3. Under the control of the third node signal of the third node N3, the first transistor M1 is electrically connected to the second clock signal terminal XCK and the first plate of the first capacitor C1.

Exemplarily, as shown in FIGS. 1 and 5, the first transistor M1 includes a P-type transistor.

When the gate driver circuit 10 is operating, during at least one of the periods during which the second input signal terminal IN2 provides an enable level, the enable level refers to a signal that can control the fourth output sub-circuit 222 to be turned on. For example, when the fourth output sub-circuit 222 includes a P-type transistor, the enable level can be the first-level signal. As shown in the third period t13 and the fourth period t14 in FIGS. 2 and 6, the first-level signal is written to the third node N3 via the second input signal terminal IN2 to control the first transistor M1 to be turned on, and the signal of the second clock signal terminal XCK is written to the first plate of the first capacitor C1 through the turned-on first transistor M1 to charge the first plate of the first capacitor C1.

During at least one of the periods during which the second input signal terminal IN2 provides the enable level and the signal of the second clock signal terminal XCK jumps from the second-level signal to the first-level signal, that is, at least at time T1 shown in FIGS. 2 and 6, under the coupling of the first capacitor C1, the third node signal of the third node N3 jumps from the first-level signal to the third-level signal, thereby controlling the signal provided by the first-level signal terminal VGL to be stably output through the fourth output sub-circuit 222.

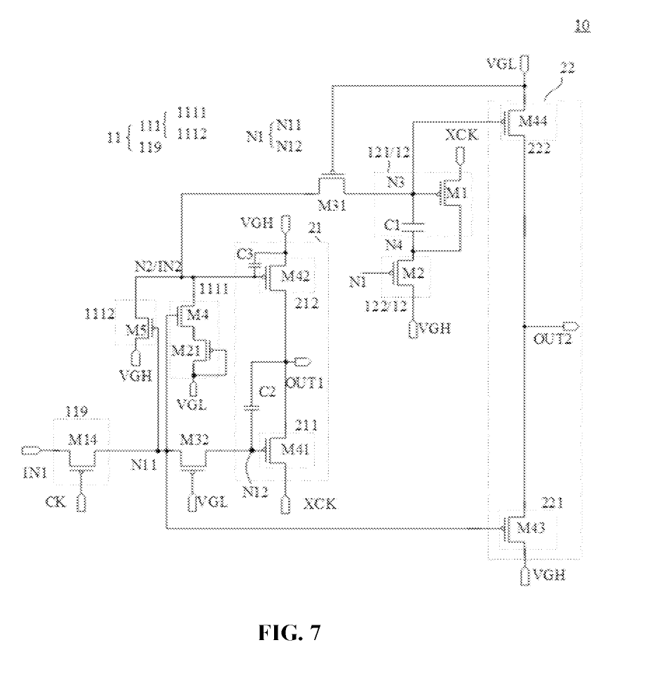

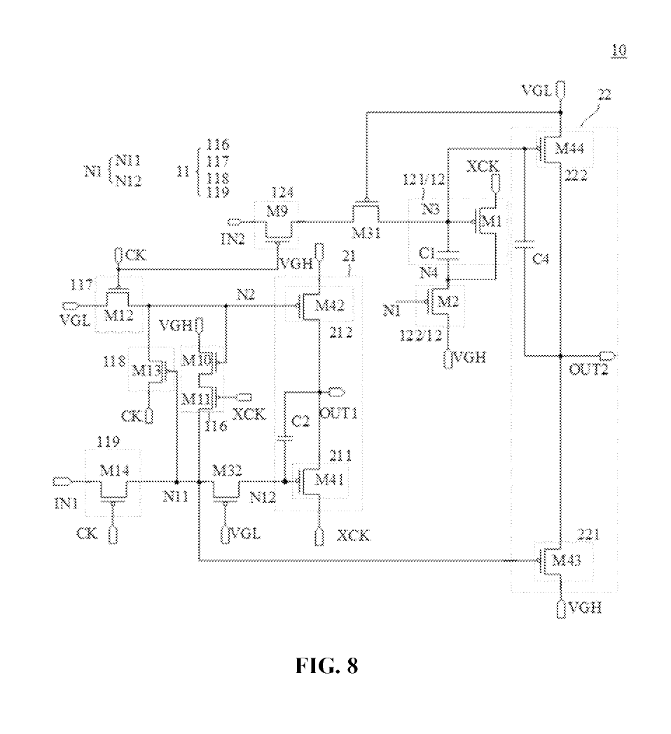

Optionally, as shown in FIGS. 7 and 8, which are another two schematic diagrams of a gate driver circuit provided in some embodiments of the present disclosure, FIG. 7 illustrates an example where the second node N2 is reused as the second input signal terminal IN2, that is, the third node N3 is electrically connected to the second node N2, and FIG. 8 illustrates an example where the third node N3 is electrically connected to the second input signal terminal IN2 via the fifth writing unit 124. In addition to the above first adjustment unit 121, some embodiments of the present disclosure can provide a second adjustment unit 122 in the second driver circuit 12, and the second adjustment unit 122 is electrically connected to the first node N1, the second-level signal terminal VGH, and the first plate of the first capacitor C1, and is configured to charge the first plate of the first capacitor C1 based on the first node signal and the second-level signal of the second-level signal terminal VGH.

In view of the above configuration, when an enable level, such as the first-level signal, is provided by the first node N1, that is, during the first period t11 and the second period t12 shown in FIGS. 2 and 6, the first node N1 controls the second adjustment unit 122 to be turned on, and the second-level signal provided by the second-level signal terminal VGH can be written to the first plate of the first capacitor C1, that is, the second-level signal is stably written to the fourth node N4 shown in FIGS. 7 and 8, so as to stabilize the potential of the first plate of the first capacitor C1, and further stabilize the potential of the second plate of the first capacitor C1, that is, the potential of the third node N3, during the first period t11 and the second period t12.

Exemplarily, as shown in FIGS. 7 and 8, the second adjustment unit 122 comprises a second transistor M2, a gate of the second transistor M2 is electrically connected to the first node N1, and a first electrode and a second electrode of the second transistor M2are electrically connected to the second-level signal terminal VGH and the first plate of the first capacitor C1, respectively.

Exemplarily, the second transistor M2 includes a P-type transistor. When the first-level signal is provided by the first node N1, for example, during the first period t11 and the second period t12 shown in FIGS. 2 and 6, the second transistor M2 is turned on, and the second-level signal provided by the second-level signal terminal VGH is written to the first plate of the first capacitor C1 to stabilize the potential of the first plate of the first capacitor C1, thereby stabilizing the potential of the second plate of the first capacitor C1, that is, the potential of the third node N3, during the first period t11 and the second period t12.

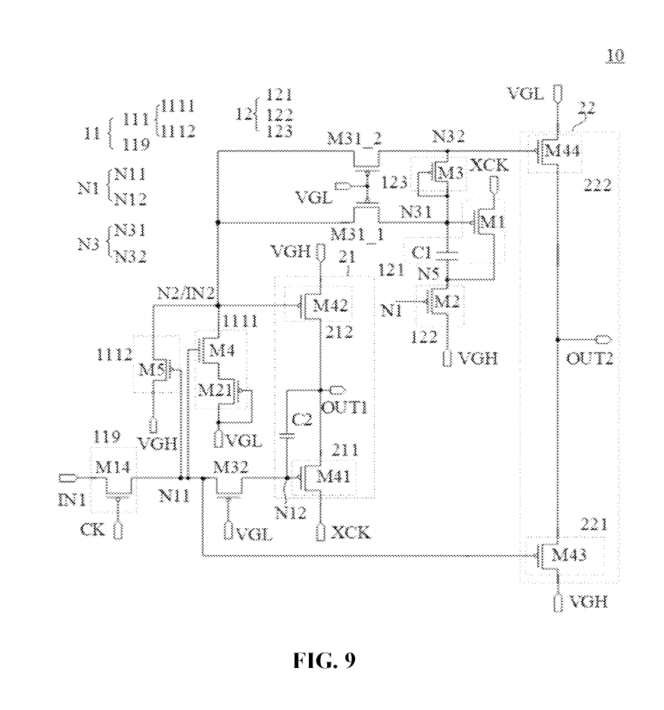

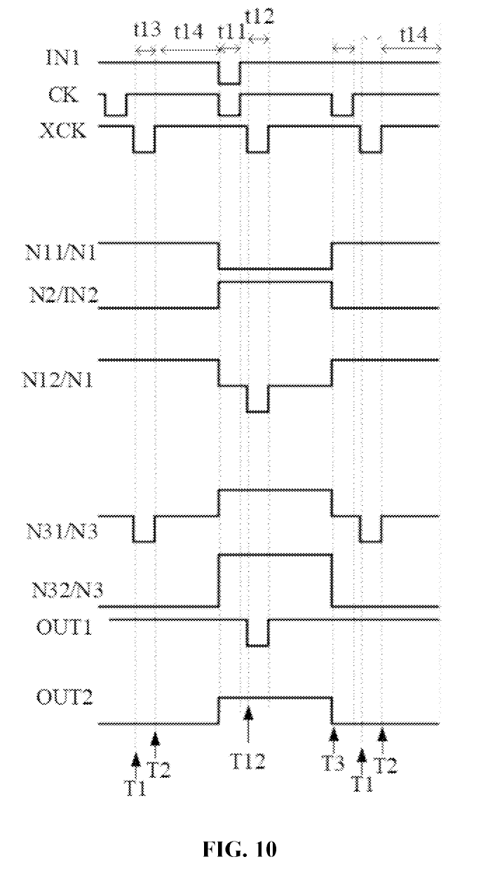

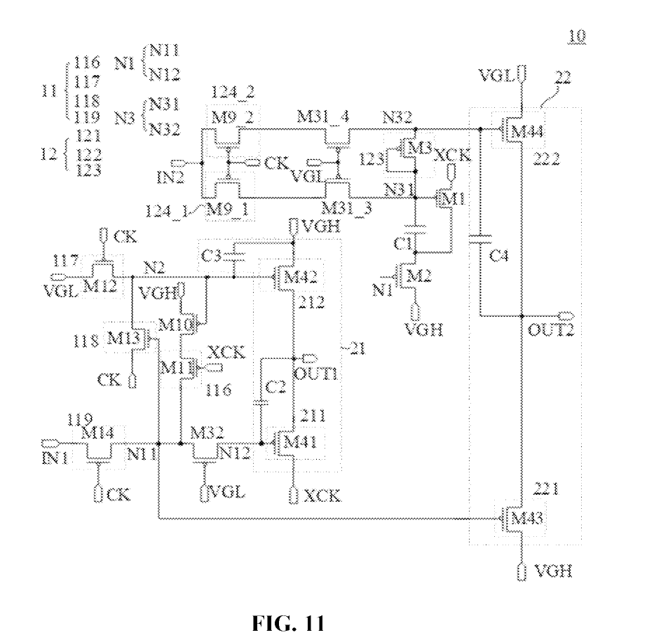

For example, as shown in FIGS. 9 to 12 in which FIGS. 9 and 11 are another two schematic diagrams of a gate driver circuit provided in some embodiments of the present disclosure, FIG. 10 is an operating timing diagram of the gate driver circuit shown in FIG. 9, and FIG. 12 is an operating timing diagram of the gate driver circuit shown in FIG. 11, in some embodiments of the present disclosure, the third node N3 can be set to include a first sub-node N31 and a second sub-node N32, the first sub-node N31 is electrically connected to the first adjustment unit 121, that is, a first sub-node signal of the first sub-node N31 can be adjusted to a third-level signal by the first adjustment unit 121 during the third period t13 shown in FIGS. 10 and 12.

As shown in FIGS. 9 and 11, the second sub-node N32 is electrically connected to the fourth output sub-circuit 222, that is, the fourth output sub-circuit 222 is electrically connected to the first-level signal terminal VGL and the second output terminal OUT2 under the control of the second sub-node N32.

As shown in FIGS. 9 and 11, the second driver circuit 12 includes an isolation unit 123 electrically connecting the first sub-node N31 and the second sub-node N32.

In some embodiments of the present disclosure, the second input signal terminal IN2 is electrically connected to the first sub-node N31 and the second sub-node N32. The first sub-node N31 and the second sub-node N32 can receive the signal provided by the second input signal terminal IN2.

With reference to FIGS. 10 and 12, during the third period t13, the first adjustment unit 121 can pull the first sub-node signal of the first sub-node N31 down to the third-level signal. When the first sub-node N31 is at the third-level signal, the isolation unit 123 is turned on, and the first sub-node N31 and the second sub-node N32 are electrically connected to each other. Therefore, the third-level signal of the first sub-node N31 can be written to the second sub-node N32 during the third period t13.

When entering the fourth period t14, that is, at time T2, the second clock signal terminal XCK jumps from the first-level signal to the second-level signal. Under the action of the above first adjustment unit 121, the first sub-node signal of the first sub-node N31 increases from the above third-level signal to the first-level signal, and the isolation unit 123 is disconnected. That is, the connection between the first sub-node N31 and the second sub-node N32 is disconnected. The second sub-node signal of the second sub-node N32 can maintain the third-level signal during the fourth period t14 when the second clock signal terminal XCK is at the second-level signal, so that the fourth output sub-circuit 222 can continue to be controlled to be stably turned on, and the first-level signal provided by the first-level signal terminal VGL is stably output to the second output terminal OUT2.

Optionally, as shown in FIGS. 9 and 11, the isolation unit 123 includes a third transistor M3, a gate and a first electrode of the third transistor M3 are electrically connected to the first sub-node N31, and a second electrode of the third transistor M3 is electrically connected to the second sub-node N32.

Optionally, the third transistor M3 includes a P-type transistor. At time T2, the second clock signal terminal XCK jumps from the first-level signal to the second-level signal. Under the action of the first adjustment unit 121, the first sub-node signal of the first sub-node N31 increases from the third-level signal to the first-level signal. The third transistor M3 is turned off, that is, the connection between the first sub-node N31 and the second sub-node N32 is disconnected. The second sub-node signal of the second sub-node N32 can maintain the third-level signal during the period in which the second clock signal terminal XCK is at the second-level signal. Therefore, the fourth output sub-circuit 222 can continue to be stably turned on, so that the first-level signal provided by the first-level signal terminal VGL is stably output to the second output terminal OUT2.

For example, as shown in FIGS. 1, 7, and 9, in some embodiments of the present disclosure, the second input signal terminal IN2 can be electrically connected to the second node N2, that is, the third node N3 can be electrically connected to the second node N2. Based on such configuration, the second node N2 can serve as a signal source to provide a signal to the third node N3 without additionally providing a new signal terminal to provide the third node signal to the third node N3, which is conducive to simplifying the structure of the gate driver circuit 10.

In the case that the third node N3 includes the first sub-node N31 and the second sub-node N32, exemplarily, as shown in FIG. 9, the electrical connection between the third node N3 and the second node N2 includes that both the first sub-node N31 and the second sub-node N32 are electrically connected to the second node N2.

Optionally, as shown in FIGS. 2 and 10, during the first period t11, in some embodiments of the present disclosure, the first-level signal of the first node N1 can be set to be an enable level, and the second-level signal of the second node N2 can be set to be a disable level. FIGS. 2 and FIG. 10 illustrate that the enable level of the first node N1 is the first-level signal and the disable level of the second node N2 is the second-level signal. Based on such configuration, as shown in FIGS. 1, 7, and 9, in a case that the third node N3 is electrically connected to the second node N2, that is, the second node N2 is reused as the second input signal terminal IN2 to simplify the structure of the gate driver circuit 10, the first node N1 can control the third output sub-circuit 221 to be turned on during the first period t11, and the third node N3 can control the fourth output sub-circuit 222 to be turned off during the first period t11. That is, the third output sub-circuit 221 and the fourth output sub-circuit 222 can be prevented from being turned on at the same time during the first period t11, and the second output circuit 22 can be prevented from being short-circuited.

When the first driver circuit 11 is provided, exemplarily, as shown in FIG. 1, in some embodiments of the present disclosure, a first writing unit 111 electrically connected to the second node N2 can be provided in the first driver circuit 11. The first writing unit 111 includes a first writing sub-unit 1111 and a second writing sub-unit 1112. The first writing sub-unit 1111 is configured to receive the first node signal and is electrically connected to the second-level signal terminal VGH and the second node N2. The second writing sub-unit 1112 is configured to receive the first node signal and is electrically connected to the first-level signal terminal VGL and the second node N2. The first writing sub-unit 1111 is turned on when the first node signal is a first level, and the second writing sub-unit 1112 is turned on when the first node signal is a second level.

In the case that the first node N1 is a first-level signal, that is, during the first period t11 and the second period t12 shown in FIG. 2, the first writing sub-unit 1111 is turned on, and the second-level signal provided by the second-level signal terminal VGH can be v to the second node N2 through the turned-on first writing sub-unit 1111, that is, the second node N2 is at a disable level, thereby preventing the fourth output sub-circuit 222 from being turned on during the first period t11 and the second period t12.

Moreover, based on such configuration, when the first node signal of the first node N1 is a second-level signal, that is, during the third period t13 and the fourth period t14 shown in FIG. 2, the second writing sub-unit 1112 is turned on, and the first-level signal provided by the first-level signal terminal VGL can be written to the second node N2 through the turned-on second writing sub-unit 1112, that is, the second node N2 is at the enable level, so that the fourth output sub-circuit 222 can be controlled to be turned on during the third period t13 and the fourth period t14.

It can be seen that based on such configuration, during any period when the gate driver circuit 10 is operating, one of the first node signal of the first node N1 and the second node signal of the second node N2 can be an enable level and the other can be a disable level, that is, a situation where both are the enable levels at the same time can be avoided. In view of the above, in some embodiments of the present disclosure, the second node N2 can be reused as the above second input signal terminal IN2, that is, the second node N2 is electrically connected to the third node N3, that is, during the first period t11 and the second period t12, the first node N1 can control both the first output sub-circuit 211 and the third output sub-circuit 221 to be turned on, that is, the first output sub-circuit 211 can output the first control signal including the enable level during the second period t12, and the third output sub-circuit 221 can output the second control signal including the enable level during the second period t12. In addition, during the third period t13 and the fourth period t14, the second node N2 can control both the second output sub-circuit 212 and the fourth output sub-circuit 222 to be turned on, so that the second output sub-circuit 212 outputs the first control signal including the disable level during the third period t13 and the fourth period t14, and the fourth output sub-circuit 222 outputs the second control signal including the disable level during the third period t13 and the fourth period t14, which is beneficial to simplify the structure of the gate driver circuit 10 while ensuring the normal operation of the gate driver circuit 10.

Optionally, as shown in FIGS. 1, 7, and 9, the first writing sub-unit 1111 includes a fourth transistor M4, and the second writing sub-unit 1112 includes a fifth transistor M5. A gate of the fourth transistor M4 is electrically connected to the first node N1, a first electrode of the fourth transistor M4 is electrically connected to the first-level signal terminal VGL, and a second electrode of the fourth transistor M4 is electrically connected to the second node N2. A gate of the fifth transistor M5 is electrically connected to the first node N1, a first electrode of the fifth transistor M5 is electrically connected to the second-level signal terminal VGH, and a second electrode of the fifth transistor M5 is electrically connected to the second node N2.

When the gate driver circuit 10 is operating, as shown in FIGS. 2 and 10, during the third period t13 and the fourth period t14, the first node signal of the first node N1 is an enable level, for example, the second-level signal, capable of controlling the fourth transistor M4 to be turned on, the fourth transistor M4 is turned on, and the first-level signal provided by the first-level signal terminal VGL is written to the second node N2 through the fourth transistor M4.

During the first period t11 and the second period t12, the first node signal of the first node N1 is an enable level, for example, the first-level signal, capable of controlling the fifth transistor M5 to be turned on. The fifth transistor M5 is turned on, and the second-level signal provided by the second-level signal terminal VGH is written to the second node N2 through the fifth transistor M5.

Optionally, as shown in FIGS. 1, 7, and 9, the fourth transistor M4 includes an N-type transistor, and the fifth transistor M5 includes a P-type transistor.

Optionally, as shown in FIGS. 1, 7, and 9, the first writing sub-unit 1111 includes an auxiliary transistor M21, a gate of the auxiliary transistor M21 is electrically connected to the first-level signal terminal VGL, a first electrode of the auxiliary transistor M21 is electrically connected to the first-level signal terminal VGL, and a second electrode of the auxiliary transistor M21 is electrically connected to the fourth transistor M4; the auxiliary transistor M21 includes a P-type transistor.

In the embodiments of the present disclosure, by providing the auxiliary transistor M21, the potential of the first electrode of the fourth transistor M4 can be raised, compared with directly electrically connecting the first electrode of the fourth transistor M4 and the first-level signal terminal VGL. In a case that a voltage value of the first-node signal of the first node N1 is negative and its absolute value is smaller than an absolute value of a voltage of the first-level signal transmitted by the first input signal terminal IN1 during the first period t11, it can be ensured that a voltage difference between the gate and the first electrode of the fourth transistor M4 maintains to be smaller than its threshold voltage. That is, it can prevent the fourth transistor M4 from being wrongly turned on during the first period t11 and the second period t12, thereby preventing a high level provided by the second-level signal terminal VGH from being written to the second node N2 during the first period t11 or the second period t12, and ensuring the accuracy of the operation of the gate driver circuit 10.

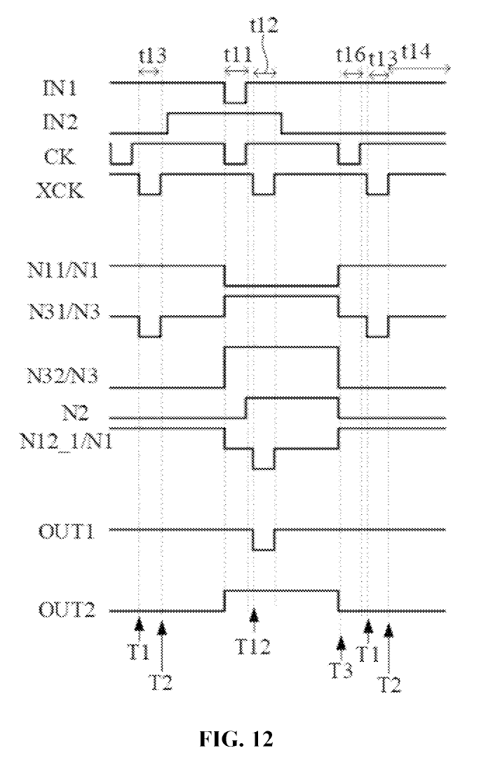

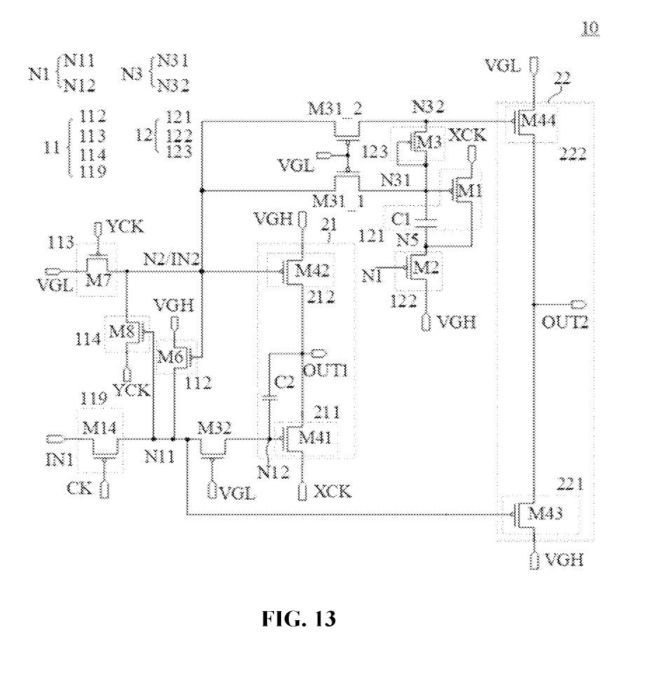

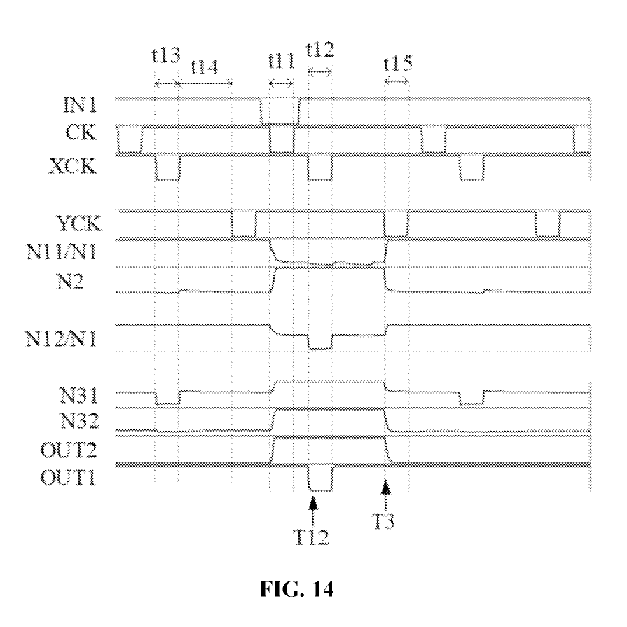

In another optional embodiment, optionally, as shown in FIGS. 13 and 14 in which FIG. 13 is a schematic diagram of a gate driver circuit provided by some embodiments of the present disclosure, and FIG. 14 is an operating timing diagram of the gate driver circuit shown in FIG. 13, in some embodiments of the present disclosure, the first driver circuit 11 can include a second writing unit 112, a third writing unit 113 and a fourth writing unit 114; the second writing unit 112 is configured to receive the second node signal and is electrically connected to the second-level signal terminal VGH and the first node N1; the third writing unit 113 is electrically connected to the third clock signal terminal YCK and the first-level signal terminal VGL, and is configured to output the second node signal based on the signal of the third clock signal terminal YCK and the signal of the first-level signal terminal VGL; the fourth writing unit 114 is configured to receive the first node signal and is electrically connected to the third clock signal terminal YCK and the second node N2.

In the embodiments of the present disclosure, exemplarily, as shown in FIG. 14, the signal of the first clock signal terminal CK, the signal of the second clock signal terminal XCK, and the signal of the third clock signal terminal YCK are pulse signals having a same period. Exemplarily, the pulse signals can switch between a first-level signal and a second-level signal. A pulse width of a low level of the pulse signal is smaller than or equal to a pulse width of a high level. The signal of the first clock signal terminal CK, the signal of the second clock signal terminal XCK, and the signal of the third clock signal terminal YCK have phase differences.

Optionally, as shown in FIG. 14, the period of the third clock signal terminal YCK can be the same as the period of the first clock signal terminal CK and the same as the period of the second clock signal terminal XCK. Furthermore, the first-level signal of the third clock signal terminal YCK is staggered from the first-level signal of the first clock signal terminal CK and the first-level signal of the second clock signal terminal XCK.

In the case that the first node signal of the first node N1 is an enable level, that is, the first-level signal, for example, during the first period t11 and the second period t12 in FIG. 14, the fourth writing unit 114 is turned on under the control of the first node N1. At this time, the signal of the third clock signal terminal YCK is the second-level signal. Therefore, the second-level signal provided by the third clock signal terminal YCK can be stably written to the second node N2 through the fourth writing unit 114, so that the signals of the first node N1 and the second node N2 are prevented from being written by the first-level signal at the same time.

In the case that the third clock signal terminal YCK is the first-level signal, for example, during the fifth period t15 shown in FIG. 14, the third writing unit 113 is turned on under the control of the third clock signal terminal YCK, and the first-level signal provided by the first-level signal terminal VGL can be written to the second node N2 through the third writing unit 113, thereby controlling the above second writing unit 112 and the second output sub-circuit 212 to be turned on, so that the second-level signal provided by the above-mentioned second-level signal terminal VGH is written to the first node N1 through the second writing unit 112, and is output to the first output terminal OUT1 through the second output sub-circuit 212.

Optionally, as shown in FIG. 13, in some embodiments of the present disclosure, the third node N3 can be electrically connected to the second node N2, thus there is no need to provide an additional terminal in the gate driver circuit 10 for providing a signal to the third node N3, thereby simplifying the structure of the gate driver circuit 10. In this case, as shown in FIG. 14, the first-level signal is also written to the third node signal of the third node N3 during the fifth period t15, thereby controlling the fourth output sub-circuit 222 to be turned on, so that the signal provided by the first-level signal terminal VGL is output to the second output terminal OUT2 through the fourth output sub-circuit 222 during the fifth period t15.

Optionally, as shown in FIG. 13, the second writing unit 112 includes a sixth transistor M6, a gate of the sixth transistor M6 is electrically connected to the second node N2, a first electrode of the sixth transistor M6 is electrically connected to the second-level signal terminal VGH, and a second electrode of the sixth transistor M6 is electrically connected to the first node N1. The third writing unit 113 includes a seventh transistor M7, a gate of the seventh transistor M7 is electrically connected to the third clock signal terminal YCK, a first electrode of the seventh transistor M7 is electrically connected to the first-level signal terminal VGL, and a second electrode of the seventh transistor M7 is electrically connected to the second node N2. The fourth writing unit 114 includes an eighth transistor M8, a gate of the eighth transistor M8 is electrically connected to the first node N1, a first electrode of the eighth transistor M8 is electrically connected to the third clock signal terminal YCK, and a second electrode of the eighth transistor M8 is electrically connected to the second node N2.

Exemplarily, as shown in FIGS. 5, 8, and 11, in some embodiments of the present disclosure, the second driver circuit 12 can include a fifth writing unit 124 electrically connected to the second input signal terminal IN2 and the first clock signal terminal CK, and the fifth writing unit 124 is configured to output a third node signal based on the signal of the first clock signal terminal CK and the signal of the second input signal terminal IN2.

As shown in FIGS. 6 and 12, in addition to providing a disable level (a level capable of controlling the fourth output sub-circuit 222 to be turned off, which is illustrated in FIGS. 6 and 12 as the second-level signal) during the second period t12, the second input signal terminal IN2 is configured to provide a disable level to the third node signal during at least one of the periods during which the second control signal is the disable level. As shown in FIGS. 6 and 12, the second input signal terminal IN2 provides a disable level during the first period t11, and the disable level is the second-level signal in FIGS. 6 and 12.

Exemplarily, as shown in FIGS. 5, 8, and 11, the fifth writing unit 124 includes a ninth transistor M9; a gate of the ninth transistor M9 is electrically connected to the first clock signal terminal CK, and a first electrode and a second electrode of the ninth transistor M9 are electrically connected to the second input signal terminal IN2 and the third node N3, respectively.

Exemplarily, in the case that the third node N3 includes the first sub-node N31 and the second sub-node N32, in some embodiments of the present disclosure, the second driver circuit 12 can include at least two fifth writing units 124. As shown in FIG. 11, the second driver circuit 12 includes two fifth writing units 124. The above second input signal terminal IN2 is electrically connected to the fourth node N4 through the fifth writing unit 124, which means that the second input signal terminal IN2 is electrically connected to the first sub-node N31 through one of the fifth writing units 124, and the second input signal terminal IN2 is electrically connected to the second sub-node N32 through another fifth writing unit 124.

To more clearly illustrate the embodiments of the present disclosure, FIG. 11 marks the fifth writing unit electrically connected to the first sub-node N31 as 124_1, and the fifth writing unit electrically connected to the second sub-node N32 as 124_2. Furthermore, the ninth transistor electrically connected to the first sub-node N31 is labeled M9_1, and the ninth transistor electrically connected to the second sub-node N32 is labeled M9_2.

With reference to FIGS. 6 and 12, when the first clock signal terminal CK provides the first-level signal, for example, at least during the first period t11, the second-level signal provided by the second input signal terminal IN2 is written to the first sub-node N31 and the second sub-node N32 through the ninth transistor M9_1 and the ninth transistor M9_2, respectively.

With reference to FIGS. 6 and 12, during the first period t11, the first clock signal terminal CK provides the first-level signal, the ninth transistor M9 is turned on, and the second-level signal provided by the second input signal terminal IN2 is written to the third node N3 through the turned-on ninth transistor M9 to control the fourth output sub-circuit 222 to be turned off.

Furthermore, during a sixth period t16, the first clock signal terminal CK provides the first-level signal, the ninth transistor M9 is turned on, the first-level signal provided by the second input signal terminal IN2 is written to the third node N3 through the turned-on ninth transistor M9, and the fourth output sub-circuit 222 is controlled to be turned on, so that the first-level signal provided by the first-level signal terminal VGL is written to the second output terminal OUT2 through the fourth output sub-circuit 222.

In the cast that the third node N3 includes the first sub-node N31 and the second sub-node N32, exemplarily, as shown in FIGS. 11 and 12, during the sixth period t16, the first clock signal terminal CK provides the first-level signal, the ninth transistor M9_1 and the ninth transistor M9_2 are turned on, the first-level signal provided by the second input signal terminal IN2 is written to the first sub-node N31 through the turned-on ninth transistor M9_1 to control the first transistor M1 to be turned on, and the second-level signal provided by the second clock signal terminal XCK is written to the first plate of the first capacitor C1 through the turned-on first transistor M1.

Furthermore, the first-level signal provided by the second input signal terminal IN2 is written to the second sub-node N32 through the turned-on ninth transistor M9_2 to control the fourth output sub-circuit 222 to be turned on, so that the first-level signal provided by the first-level signal terminal VGL is written to the second output terminal OUT2 via the fourth output sub-circuit 222. When the second control signal provided by the second output terminal OUT2 changes from the second-level signal to the first-level signal, that is, at time T3 shown in FIG. 6, the potential of the third node N3 shown in FIG. 5 is coupled to a potential lower than the potential of the first-level signal under the coupling of the fourth capacitor C4 shown in FIG. 5. Alternatively, at time T3 shown in FIG. 12, the potential of the second sub-node N32 shown in FIG. 11 is coupled to a potential lower than the potential of the first-level signal under the coupling of the fourth capacitor C4 shown in FIG. 11.

In another optional embodiment of the first driver circuit 11, as shown in FIGS. 5, 8, and 11, the first driver circuit 11 includes a sixth writing unit 116, a seventh writing unit 117 and an eighth writing unit 118. The sixth writing unit 116 is configured to receive the second node signal and the signal of the second clock signal terminal XCK and is electrically connected to the second-level signal terminal VGH and the first node N1; the seventh writing unit 117 is electrically connected to the first clock signal terminal CK and the first-level signal terminal VGL, and is configured to output the second node signal based on the signal of the first clock signal terminal CK and the signal of the first-level signal terminal VGL; the eighth writing unit 118 is configured to receive the first node signal and is electrically connected to the first clock signal terminal CK and the second node N2.

Exemplarily, as shown in FIGS. 5, 8, and 11, the sixth writing unit 116 includes a tenth transistor M10 and an eleventh transistor M11. A gate of the tenth transistor M10 is electrically connected to the second node N2, a first electrode of the tenth transistor M10 is electrically connected to the second-level signal terminal VGH, and the second electrode of the tenth transistor M10 is electrically connected to the first electrode of the eleventh transistor M11. A gate of the eleventh transistor M11 is electrically connected to the second clock signal terminal XCK, and a second electrode of the eleventh transistor M11 is electrically connected to the first node N1. The seventh writing unit 117 includes a twelfth transistor M12, a gate of the twelfth transistor M12 is electrically connected to the first clock signal terminal CK, a first electrode of the twelfth transistor M12 is electrically connected to the first-level signal terminal VGL, and a second electrode of the twelfth transistor M12 is electrically connected to the second node N2. The eighth writing unit 118 includes a thirteenth transistor M13, a gate of the thirteenth transistor M13 is electrically connected to the first node N1, a first electrode of the thirteenth transistor M13 is electrically connected to the first clock signal terminal CK, and a second electrode of the thirteenth transistor M13 is electrically connected to the second node N2.

It should be noted that, the structures of the first driver circuit 11 in FIGS. 5, 8, and 11 are for illustration only. In some embodiments of the present disclosure, the first driver circuit 11 in FIGS. 5, 8, and 11 can also be designed in the manner as shown in FIG. 1 or FIG. 13 as described above, and the embodiments of the present disclosure will not be repeated herein.

Optionally, as shown in FIGS. 1, 5, 7, 8, 9, 11, and 13, the gate driver circuit 10 includes a first protection transistor M31 electrically connected between the second input signal terminal IN2 and the third node N3 and having a gate electrically connected to the first-level signal terminal VGL.

In the case that the third node signal of the third node N3 is coupled to the third-level signal due to providing the first adjustment unit 121, the first protection transistor M31 is turned off, thereby insulating the second input signal terminal IN2 from the third node N3, preventing the third-level signal of the third node N3 from reducing the reliability of the transistor connected to the second input signal terminal IN2.

Exemplarily, in the case that the second input signal terminal IN2 is electrically connected to the second node N2, as shown in FIGS. 1, 7, 9, and 13, the first protection transistor M31 is electrically connected between the second node N2 and the third node N3. When the potential of the third node N3 changes to the third-level signal under the action of the first adjustment unit 121, the first protection transistor M31 is turned off, so that the second node N2 maintains at the first-level signal, thereby improving the reliability of the transistor electrically connected to the second node N2.

Optionally, in the case that the second input signal terminal IN2 is electrically connected to the third node N3 through the fifth writing unit 124, as shown in FIGS. 5, 8, and 11, the first protection transistor M31 is electrically connected between the fifth writing unit 124 and the third node N3. When the third node signal of the third node N3 changes to the third-level signal, the potential of the electrode of the fifth writing unit 124 electrically connected to the first protection transistor M31 can be protected to maintain the first-level signal, thereby improving the reliability of the transistor in the fifth writing unit 124.

It should be noted that in the case that the third node N3 is divided into the first sub-node N31 and the second sub-node N32, the number of the above first protection transistors M31 can also be two, and as shown in FIGS. 9 and 11, one of the first protection transistors M31 is electrically connected to the first sub-node N31, and the other first protection transistor M31 is electrically connected to the second sub-node N32.

To more clearly illustrate the embodiments of the present disclosure, in FIG. 9, the first protection transistor connected between the second node N2 and the first sub-node N31 is marked as M31_1, and the first protection transistor connected between the second node N2 and the second sub-node N32 is marked as M31_2.

In FIG. 11, the first protection transistor connected between the fifth writing unit 124 and the first sub-node N31 is marked as M31_3, and the first protection transistor connected between the fifth writing unit 124 and the second sub-node N32 is marked as M31_4.

When the first sub-node signal of the first sub-node N31 changes to the third-level signal, that is, during the third period t13 shown in FIG. 12, the first protection transistor M31_3 is turned off, which can protect the potential of the electrode of the ninth transistor M9_1 electrically connected to the first protection transistor M31_3 to maintain the first-level signal, thereby improving the reliability of the ninth transistor M9_1.

Furthermore, when the second sub-node signal of the second sub-node N32 changes to the third-level signal, that is, during the sixth period t16, the third period t13 and the fourth period t14 shown in FIG. 12, the first protection transistor M31_4 is turned off, which can protect the potential of one electrode of the ninth transistor M9_2 electrically connected to the first protection transistor M31_4 to maintain the first-level signal, thereby improving the reliability of the ninth transistor M9_2.

Optionally, as shown in FIGS. 1, 5, 7, 8, 9, 11, and 13, the first driver circuit 11 includes a ninth writing unit 119, which is electrically connected to the first clock signal terminal CK and the first input signal terminal IN1, and which is configured to output the first node signal based on the signal of the first clock signal terminal CK and the signal of the first input signal terminal IN1.

Exemplarily, as shown in FIGS. 1, 5, 7, 8, 9, 11, and 13, the ninth writing unit 119 includes a fourteenth transistor M14, a gate of the fourteenth transistor M14 is electrically connected to the first clock signal terminal CK, a first electrode of the fourteenth transistor M14 is electrically connected to the first input signal terminal IN1, and a second electrode of the fourteenth transistor M14 is electrically connected to the first node N1.

When the gate driver circuit 10 is operating, as shown in FIGS. 2, 6, 10, 12, and 14, during the first period t11, the first clock signal terminal CK provides the first-level signal to control the fourteenth transistor M14 to be turned on, and the first-level signal provided by the first input signal terminal IN1 can be written to the first node N1 through the turned-on fourteenth transistor M14 to control the first output sub-circuit 211 and the third output sub-circuit 221 to be turned on.

Furthermore, during the sixth period t16, the first clock signal terminal CK provides the first-level signal to control the fourteenth transistor M14 to be turned on, and the second-level signal provided by the first input signal terminal IN1 can be written to the first node N1 through the turned-on fourteenth transistor M14 to control the first output sub-circuit 211 and the third output sub-circuit 221 to be turned off.

Exemplarily, as shown in FIGS. 1, 5, 7, 8, 9, 11, and 13, the first node N 1 includes a third sub-node N11 and a fourth sub-node N12.

The first driver circuit 11 includes a second protection transistor M32 electrically connecting the third sub-node N11 and the fourth sub-node N12. A gate of the second protection transistor M32 is electrically connected to the first-level signal terminal VGL. The third sub-node N11 is electrically connected to the ninth writing unit 119, and the fourth sub-node N12 is electrically connected to the first output sub-circuit 211.

In conjunction with FIGS. 2, 6, 10, 12, and 14, when the signal of the second clock signal terminal XCK jumps from the second-level signal to the first-level signal, that is, at time T12, the fourth sub-node signal of the fourth sub-node N12 drops from the first-level signal to a potential lower than the first-level signal under the coupling of the second capacitor C2. At this time, the second protection transistor M32 is turned off, which can prevent the third sub-node signal of the third sub-node N11 from dropping to a potential lower than the first-level signal. That is, the second protection transistor M32 is provided to prevent the potential lower than the first-level signal from being transmitted between the third sub-node N11 and the fourth sub-node N12, which is beneficial to improving the reliability of the transistor in the ninth writing unit 119 electrically connected to the third sub-node N11.

It should be noted that the third output sub-circuit 221 is electrically connected to the first node N1, which includes that the third output sub-circuit 221 is electrically connected to the third sub-node N11 or the fourth sub-node N12. FIGS. 1, 5, 7, 8, 9, 11, and 13 all illustrates that the third output sub-circuit 221 is electrically connected to the third sub-node N11.

For example, as shown in FIGS. 1, 5, 7, 8, 9, 11, and 13, the first output sub-circuit 211 includes a first output transistor M41, a gate of the first output transistor M41 is electrically connected to the first node N1, a first electrode of the first output transistor M41 is electrically connected to the second clock signal terminal XCK, and a second electrode of the first output transistor M41 is electrically connected to the first output terminal OUT1. The second output sub-circuit 212 includes a second output transistor M42, a gate of the second output transistor M42 is electrically connected to the second node N2, a first electrode of the second output transistor M42 is electrically connected to the second-level signal terminal VGH, and a second electrode of the second output transistor M42 is electrically connected to the first output terminal OUT1.

Optionally, the first output transistor M41 and the second output transistor M42 include P-type transistors. When the first node signal of the first node N1 is the first-level signal, that is, during the first period t11 and the second period t12 shown in FIGS. 2, 6, 10, 12, and 14, the first output transistor M41 is turned on, and the signal provided by the second clock signal terminal XCK is output to the first output terminal OUT1. When the second node signal of the second node N2 is the first-level signal, that is, during the third period t13 and the fourth period t14 shown in FIGS. 2, 6, 10, 12, and 14, the second output transistor M42 is turned on, and the second-level signal provided by the second-level signal terminal VGH is output to the first output terminal OUT1.

For example, as shown in FIGS. 1, 5, 7, 8, 9, 11, and 13, the first output circuit 21 includes a second capacitor C2 electrically connecting the first node N1 and the first output terminal OUT1. The second capacitor C2 can stabilize the first node signal of the first node N1. Furthermore, when the signal of the first output terminal OUT1 jumps from the second-level signal to the first-level signal, that is, at time T12 shown in FIGS. 2, 6, 10, 12, and 14, the second capacitor C2 can couple the first node signal of the first node N1 to a potential lower than the first-level signal, thereby allowing the first output transistor M41 to be turned on more completely, and preventing the signal output from the first output terminal OUT1 from tailing.

Optionally, as shown in FIGS. 5, 9, and 11, the gate driver circuit 10 includes a third capacitor C3 electrically connecting the second node N2 and the second-level signal terminal VGH. The third capacitor C3 is provided, which can improve the stability of the second node signal of the second node N2.

For example, as shown in FIGS. 1, 5, 7, 8, 9, 11, and 13, the third output sub-circuit 221 includes a third output transistor M43, a gate of the third output transistor M43 is electrically connected to the first node N1, a first electrode of the third output transistor M43 is electrically connected to the second-level signal terminal VGH, and a second electrode of the third output transistor M43 is electrically connected to the second output terminal OUT2. The fourth output sub-circuit 222 includes a fourth output transistor M44, a gate of the fourth output transistor M44 is electrically connected to the third node N3, a first electrode of the fourth output transistor M44 is electrically connected to the first-level signal terminal VGL, and a second electrode of the fourth output transistor M44 is electrically connected to the second output terminal OUT2.

Optionally, the third output transistor M43 and the fourth output transistor M44 include P-type transistors. When the first node signal of the first node N1 is the first-level signal, that is, during the first period t11 and the second period t12 shown in FIGS. 2, 6, 10, 12, and 14, the third output transistor M43 is turned on, and the signal provided by the second-level signal terminal VGH is output to the second output terminal OUT1. When the third node signal of the third node N3 is a signal smaller than or equal to the first-level signal, that is, during the third period t13, the fourth period t14, and the sixth period t16 shown in FIGS. 2, 6, 10, and 12, the fourth output transistor M44 is turned on, and the first-level signal provided by the first-level signal terminal VGL is output to the second output terminal OUT2.

For example, as shown in FIGS. 5, 7, 8, 9, 11, and 13, the second output circuit 22 includes a fourth capacitor C4 electrically connecting the third node N3 and the second output terminal OUT2. The fourth capacitor C4 is provided, which can improve the stability of the third-node signal of the third node N3. Furthermore, when the signal of the second output terminal OUT2 jumps from the second-level signal to the first-level signal, that is, at time T3 shown in FIGS. 2, 6, 10, 12, and 14, the fourth capacitor C4 can couple the third-node signal of the third node N3 to a potential lower than the first-level signal, thereby allowing the fourth output transistor M44 to be turned on more completely, and preventing the signal output from the second output terminal OUT2 from tailing.

The operating process of the gate driver circuit is described below in conjunction with FIGS. 1 and 2.

During a first period t11, the first clock signal terminal CK provides the first-level signal, controlling the fourteenth transistor M14 to be turned on, and the first-level signal provided by the first input signal terminal IN1 is written to the third sub-node N11 and the fourth sub-node N12 through the turned-on fourteenth transistor M14. Under the control of the fourth sub-node N12, the first output transistor M41 is turned on, and the second-level signal provided by the second clock signal terminal XCK is written to the first output terminal OUT1 through the turned-on first output transistor M41.

Under the control of the third sub-node N11, the fifth transistor M5 and the third output transistor M43 are turned on, and the second-level signal provided by the second-level signal terminal VGH is written to the second node N2 and the third node N3 through the turned-on fifth transistor M5. In addition, the second-level signal provided by the second-level signal terminal VGH is written to the second output terminal OUT2 through the turned-on third output transistor M43.

Under the control of the second node N2, the second output transistor M42 is turned off.

Under the control of the third node N3, the first transistor M1 and the fourth output transistor M44 are turned off.

During the second period t12, the first clock signal terminal CK provides the second-level signal to control the fourteenth transistor M14 to be turned off, and the third sub-node N11 and the fourth sub-node N12 both maintain the first-level signal provided during the first period t11.

Under the control of the third sub-node N11, the fifth transistor M5 and the third output transistor M43 are turned on, and the second-level signal provided by the second-level signal terminal VGH is written to the second node N2 and the third node N3 through the turned-on fifth transistor M5. Under the control of the second node N2, the second output transistor M42 is turned off. Under the control of the third node N3, the first transistor M1 and the fourth output transistor M44 are turned off. The second-level signal provided by the second-level signal terminal VGH is written to the second output terminal OUT2 through the turned-on third output transistor M43.

Under the control of the fourth sub-node N12, the first output transistor M41 is turned on, and the first-level signal provided by the second clock signal terminal XCK is written to the first output terminal OUT1 through the turned-on first output transistor M41. When the signal of the first output terminal OUT1 jumps from the second-level signal to the first-level signal, that is, at time T12 shown in FIG. 2, the signal of the fourth sub-node N12 changes from the first-level signal to a signal with a lower potential than the first-level signal under the action of the second capacitor C2, so that the first output transistor M41 can stably output the first-level signal. During this period, the second protection transistor M32 is turned off, and the third sub-node N11 can maintain the first-level signal provided during the first period t11.

During the seventh period t17, the first clock signal terminal CK provides the second-level signal to control the fourteenth transistor M14 to be turned off, and the third sub-node N11 and the fourth sub-node N12 both maintain the first-level signal provided during the second period t12.

Under the control of the third sub-node N11, the fifth transistor M5 and the third output transistor M43 are turned on, and the second-level signal provided by the second-level signal terminal VGH is written to the second node N2 and the third node N3 through the turned-on fifth transistor M5. Under the control of the second node N2, the second output transistor M42 is turned off. Under the control of the third node N3, the first transistor M1 and the fourth output transistor M44 are turned off. The second-level signal provided by the second-level signal terminal VGH is written to the second output terminal OUT2 through the turned-on third output transistor M43.

Under the control of the fourth sub-node N12, the first output transistor M41 is turned on, and the second-level signal provided by the second clock signal terminal XCK is written to the first output terminal OUT1 through the turned-on first output transistor M41. When the signal of the first output terminal OUT1 jumps from the first-level signal to the second-level signal, that is, at time T26 shown in FIG. 2, the signal of the fourth sub-node N12 rises to the first-level signal under the action of the second capacitor C2.

During the sixth period t16, the first clock signal terminal CK provides the first-level signal to control the fourteenth transistor M14 to be turned on, the second-level signal provided by the first input signal terminal IN1 is written to the third sub-node N11 and the fourth sub-node N12 through the turned-on fourteenth transistor M14. Under the control of the fourth sub-node N12, the first output transistor M41 is turned off.

Under the control of the third sub-node N11, the fourth transistor M4 is turned on, and the first-level signal provided by the first-level signal terminal VGL is written to the second node N2 and the third node N3 through the auxiliary transistor M21 and the fourth transistor M4. As shown in FIGS. 9 and 10, in the case that the third node N3 includes the first sub-node N31 and the second sub-node N32, the first-level signal provided by the first-level signal terminal VGL can be written to the first sub-node N31 and the second sub-node N32 via the auxiliary transistor M21 and the fourth transistor M4.

Under the control of the second node N2, the second output transistor M42 is turned on, and the second-level signal provided by the second-level signal terminal VGH is written to the first output terminal OUT1 through the turned-on second output transistor M42.

Under the control of the third node N3, the first transistor M1 and the fourth output transistor M44 are turned on. The second-level signal provided by the second clock signal terminal XCK is written to the first plate of the first capacitor C1 through the turned-on first transistor M1 to charge the first capacitor C1. The first-level signal provided by the first-level signal terminal VGL is written to the second output terminal OUT2 through the turned-on fourth output transistor M44.

As shown in FIGS. 9 and 10, in the case that the third node N3 includes a first sub-node N31 and a second sub-node N32, the first transistor M1 is turned on under the control of the first sub-node N31. The second-level signal provided by the second clock signal terminal XCK is written to the first plate of the first capacitor C1 through the turned-on first transistor M1, thereby charging the first capacitor C1. Under the control of the second sub-node N32, the fourth output transistor M44 is turned on, and the first-level signal provided by the first-level signal terminal VGL is written to the second output terminal OUT2 through the turned-on fourth output transistor M44. The change in the signal of the second output terminal OUT2 affects the potential of the second sub-node N32 through the coupling of the parasitic capacitance between the second output terminal OUT2 and the second sub-node N32, and the signal of the second output terminal OUT2 changes from the second-level signal to the first-level signal. That is, at time T3 shown in FIG. 10, the signal of the second sub-node N32 changes from the second-level signal to a signal with a lower potential than the first-level signal.

The first-level signal provided by the first-level signal terminal VGL can be written to the first sub-node N31 and the second sub-node N32 through the auxiliary transistor M21 and the fourth transistor M4.

During the third period t13, the first clock signal terminal CK provides the second-level signal to control the fourteenth transistor M14 to be turned off, and the third sub-node N11 and the fourth sub-node N12 both maintain the second-level signal provided during the seventh period t17.

Under the control of the third sub-node N11, the fourth transistor M4 is turned on. The first-level signal provided by the first-level signal terminal VGL is written to the second node N2 and the third node N3 through the turned-on auxiliary transistor M21 and the turned-on fourth transistor M4.

Under the control of the second node N2, the second output transistor M42 is turned on, and the second-level signal provided by the second-level signal terminal VGH is written to the first output terminal OUT1 through the turned-on second output transistor M42.

Under the control of the third node N3, the first transistor M1 and the fourth output transistor M44 are turned on. The first-level signal provided by the second clock signal terminal XCK is written to the first plate of the first capacitor C1 through the turned-on first transistor M1. When the signal of the second clock signal terminal XCK jumps from the second-level signal to the first-level signal, that is, at time T1 shown in FIG. 2, the potential of the third node N3 changes from the first-level signal provided during the seventh period t17 to a potential lower than the first-level signal due to the coupling of the first capacitor C1. As a result, the fourth output transistor M44 can be controlled to be stably turned on, so that the first-level signal provided by the first-level signal terminal VGL can be stably written to the second output terminal OUT2.

Under the control of the fourth sub-node N12, the first output transistor M41 is turned off.

During the fourth period t14, the first clock signal terminal C K provides the second-level signal to control the fourteenth transistor M14 to be turned off, and the third sub-node N11 and the fourth sub-node N12 both maintain at the second-level signal provided during the third period t13.

Under the control of the third sub-node N11, the fourth transistor M4 is turned on, and the first-level signal provided by the first-level signal terminal VGL is written to the second node N2 and the third node N3 through the auxiliary transistor M21 and the fourth transistor M4.

Under the control of the second node N2, the second output transistor M42 is turned on, and the second-level signal provided by the second-level signal terminal VGH is written to the first output terminal OUT1 through the turned-on second output transistor M42.

Under the control of the third node N3, the first transistor M1 and the fourth output transistor M44 are turned on. The second-level signal provided by the second clock signal terminal XCK is written to the first plate of the first capacitor C1 through the turned-on first transistor M1. When the signal of the second clock signal terminal XCK jumps from the first-level signal to the second-level signal, that is, at time T2 shown in FIG. 2, the potential of the third node N3 rises to the first-level signal under the coupling of the first capacitor C1, to control the fourth output transistor M44 to turn on, so that the first-level signal provided by the first-level signal terminal VGL can be stably written to the second output terminal OUT2.

After that, the sixth period t16, the third period t13 and the fourth period t14 can be repeated alternately until the first input signal terminal IN1 provides the first-level signal again in a next operating cycle.

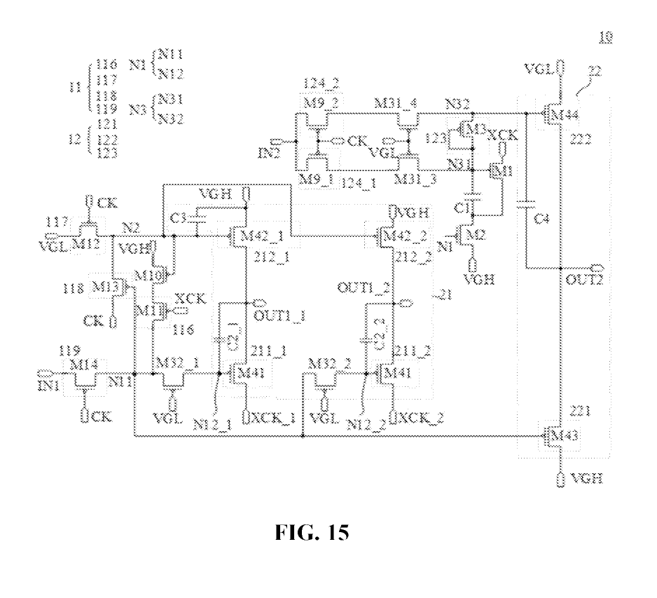

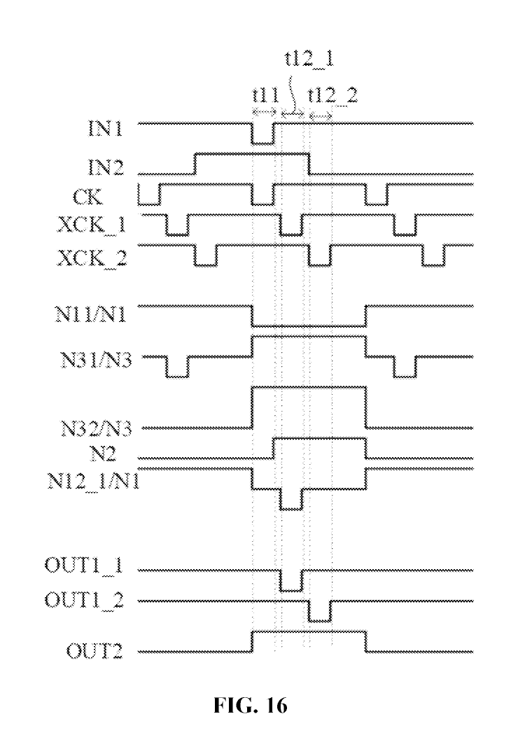

Exemplarily, with reference to FIGS. 15 and 16 in which FIG. 15 is another schematic diagram of a gate driver circuit provided in some embodiments of the present disclosure, and FIG. 16 is an operating timing diagram of the gate driver circuit shown in FIG. 15, the first output circuit 21 includes at least two of the first output sub-circuits and at least two of the second output sub-circuits. The gate driver circuit 10 includes at least two of the second clock signal terminals and at least two of the first output terminals. The at least two first output terminals are configured to provide at least two first control signals in a time-division manner, and the enable levels of the at least two first control signals are at least partially not overlapped with each other. In embodiments of the present disclosure, at least two first output sub-circuits are configured to receive the first node signal and are electrically connected to a corresponding one of the second clock signal terminals and a corresponding one of the first output terminals, respectively, and at least two second output sub-circuits are configured to receive the second node signal and are electrically connected to the second-level signal terminal and the first output terminals.

FIG. 15 provides 211_1 and 211_2 to distinguish two first output sub-circuits, provides 212_1 and 212_2 to distinguish two second output sub-circuits, provides XCK_1 and XCK_2 to distinguish two second clock signal terminals, and provides OUT1_1 and OUT1_2 to distinguish two first output terminals.

The first output sub-circuit 211_1 is electrically connected to the first node N1, the second clock signal terminal XCK_1, and the first output terminal OUT1_1. Under the control of the first node signal of the first node N1, the first output sub-circuit 211_1 is electrically connected to the second clock signal terminal XCK_1 and the first output terminal OUT1_1.

The first output sub-circuit 211_2 is electrically connected to the first node N1, the second clock signal terminal XCK_2, and the first output terminal OUT1_2. Under the control of the first node signal of the first node N1, the first output sub-circuit 211_2 is electrically connected to the second clock signal terminal XCK_2 and the first output terminal OUT1_2.

The second output sub-circuit 212_1 is electrically connected to the second node N2, the second-level signal terminal VGH, and the first output terminal OUT1_1. Under the control of the second node signal of the second node N2, the second output sub-circuit 212_1 is electrically connected to the second-level signal terminal VGH and the first output terminal OUT1_1.

The second output sub-circuit 212_2 is electrically connected to the second node N2, the second-level signal terminal VGH, and the first output terminal OUT1_2. Under the control of the second node signal of the second node N2, the second output sub-circuit 212_2 is electrically connected to the second-level signal terminal VGH and the first output terminal OUT1_2.

As shown in FIG. 15, the first output sub-circuit 211_1 includes a first output transistor M41_1, and the first output sub-circuit 211_2 includes a first output transistor M41_2. Gates of the first output transistors M41_1 and M41_2 are both electrically connected to the first node N1.

Specifically, as shown in FIG. 15, the gate driver circuit 10 includes two of the fourth sub- nodes, respectively marked as N12_1 and N12_2. The first output transistor M41_1 is electrically connected between the second clock signal terminal XCK_1 and the first output terminal OUT1_1, and has a gate electrically connected to the fourth sub-node N12_1. The first output transistor M41_2 is electrically connected between the second clock signal terminal XCK_2 and the first output terminal OUT1_2, and has a gate electrically connected to the fourth sub-node N12_2.

Exemplarily, as shown in FIG. 16, the operating process of the gate driver circuit 10 includes a first period t11 and at least two second periods. FIG. 16 illustrates two second periods t12_1 and t12_2.

During the second period t12_1, the first node N1 controls both first output transistors M41 to be turned on, the second clock signal terminal XCK_1 provides the first-level signal that can be output to the first output terminal OUT1_1 through the turned-on first output transistor M41_1, i.e., the first output terminal OUT1_1 outputs an enable level. The second clock signal terminal XCK_2 provides the second-level signal that can be output to the first output terminal OUT1_2 through another turned-on first output transistor M41_2, i.e., the first output terminal OUT1_2 outputs a disable level.

During the second period t12_2, the first node N1 controls both first output transistors M41 to be turned on, and the second clock signal terminal XCK_2 provides the first-level signal that can be output to the first output terminal OUT1_2 through the turned-on first output transistor M41_2, i.e., the first output terminal OUT1_2 outputs an enable level. The second clock signal terminal XCK_1 provides the second-level signal that can be output to the first output terminal OUT1_1 through another turned-on first output transistor M41_1, i.e., the first output terminal OUT1_1 outputs a disable level.

Based on such configuration, one gate driver circuit 10 can drive two pixel driver circuit rows, which helps to simplify the structure of the gate driver circuit 10.

Exemplarily, as shown in FIG. 15, the first output circuit 21 includes two second capacitors, one of which is marked as C2_1 and the other is marked as C2_2. The second capacitor C2_1 is electrically connected to the first output terminal OUT1_1 and the first node N1, and the second capacitor C2_2 is electrically connected to the first output terminal OUT1_2 and the first node N1.

Exemplarily, as shown in FIG. 15, the gate driver circuit 10 includes two second protection transistors, respectively marked as M32 _1 and M32 _2. The second protection transistor M32 _1 is electrically connected to the third sub-node N11 and the fourth sub-node N12_1, and the second protection transistor M32 _2 is electrically connected to the third sub-node N11 and the fourth sub-node N12_2.

Optionally, as shown in FIG. 16, the enable level of the second control signal output by the second output terminal OUT2 at least partially overlaps with the enable levels of the first control signals output by the two first output terminals OUT1.

Specifically, during the second period t12_1 and the second period t12_2, the third sub-node signal of the third sub-node N11 is always the first-level signal to control the third output transistor M43 to be turned on, the second-level signal terminal VGH provides the second-level signal output to the second output terminal OUT2 through the turned-on third output transistor M43, so that the second output terminal OUT2 outputs an enable level during the second period t12_1 and the second period t12_2, thereby driving two pixel driver circuit rows.

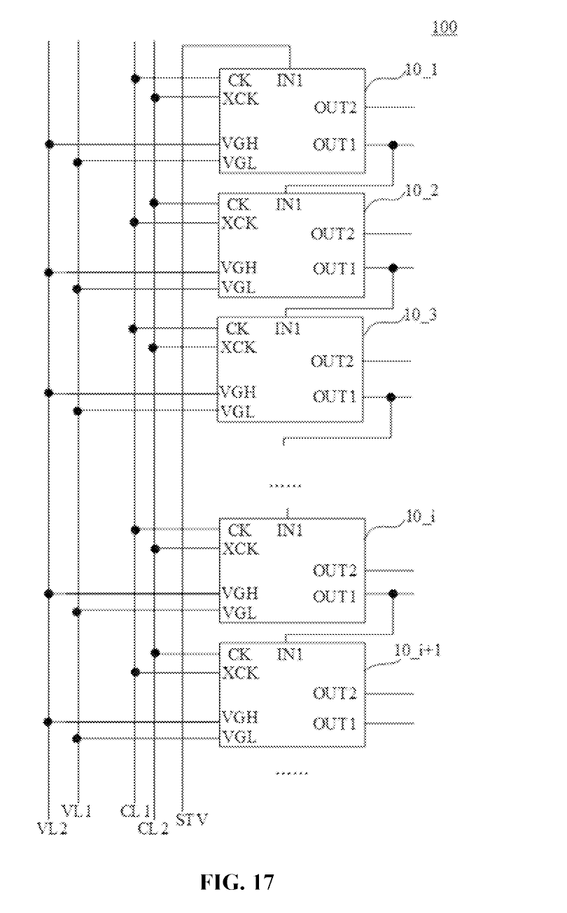

Exemplarily, some embodiments of the present disclosure provide a shift register, and as shown in FIG. 17 that is a schematic diagram of a shift register provided by some embodiments of the present disclosure, the shift register 100 includes N cascaded gate driver circuits 10 mentioned above; the first input signal terminal IN1 of the (i+1)-th stage gate driver circuit 10 receives the signal of the first output terminal OUT1 of the i-th stage gate driver circuit 10, where i is an integer, and satisfies: 1 ≤ i ≤ N-1.

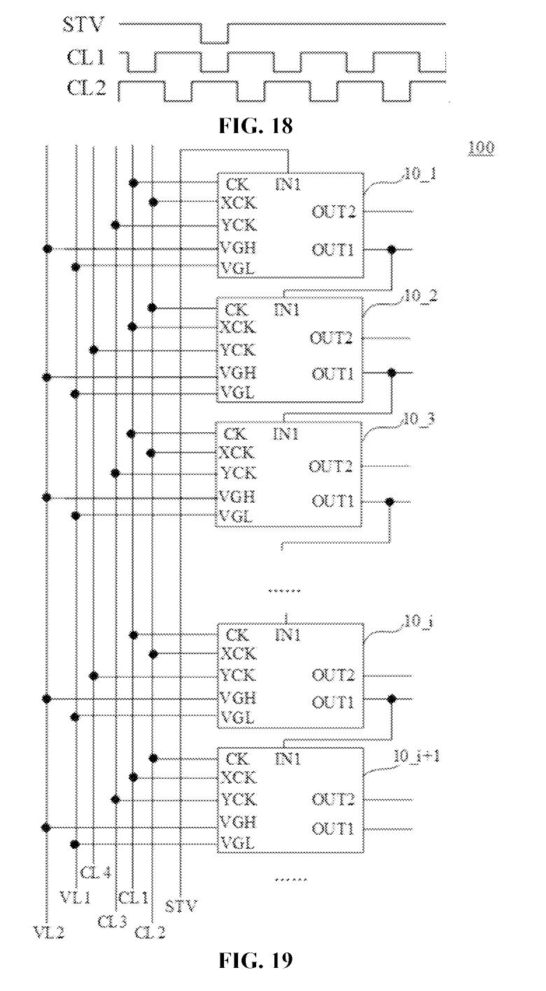

As shown in FIG. 17, the shift register 100 includes a frame start signal line STV, a first-level signal line VL1, a second-level signal line VL2, a first clock signal line CL1, and a second clock signal line CL2. The first input signal terminal IN1 of the first stage gate driver circuit 10_1 can be electrically connected to the frame start signal line STV. A timing of the frame start signal line STV, a timing of the first clock signal line CL1, and a timing of the second clock signal line CL2 are shown in FIG. 18.

In the embodiments of the present disclosure, as shown in FIG. 17, the first clock signal terminals CK of the odd-numbered stages of gate driver circuit 10 are connected to the first clock signal line CL1, and the second clock signal terminal XCK is connected to the second clock signal line CL2; the first clock signal terminals CK of the even-numbered stages of gate driver circuit 10 are connected to the second clock signal line CL2, and the second clock signal terminal XCK is connected to the first clock signal line CL1.

As shown in FIG. 18, the signal of the first clock signal line CL1 and the signal of the second clock signal line CL2 have a phase difference.

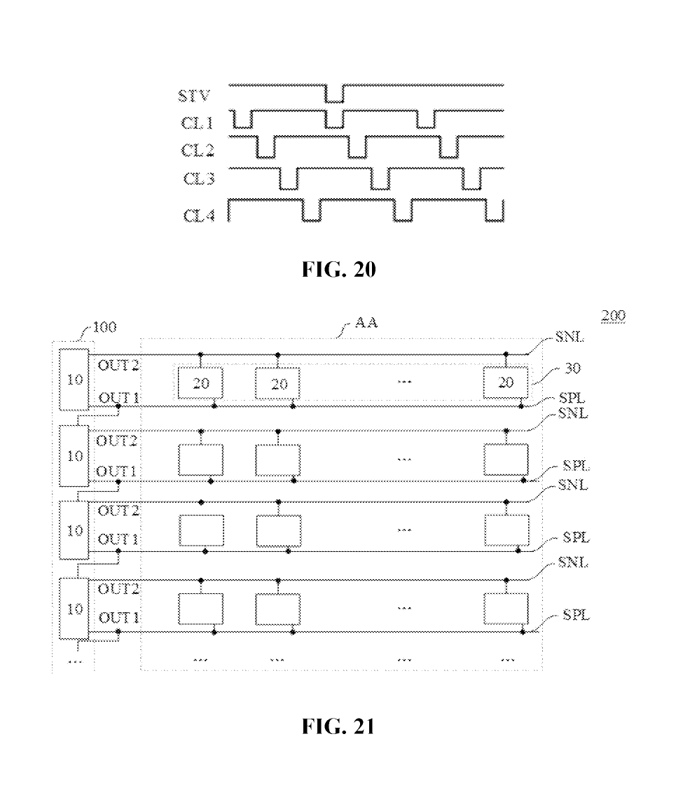

Optionally, in the case that the structure of the gate driver circuit 10 is set in the manner shown in FIG. 13, and as shown in FIGS. 19 and 20 in which FIG. 19 is a schematic diagram of a shift register provided by some embodiments of the present disclosure, in addition to the above frame start signal line STV, the first-level signal line VL1, the second-level signal line VL2, the first clock signal line CL1, and the second clock signal line CL2, the shift register 100 includes a third clock signal line CL3 and a fourth clock signal line CL4, and the timing of the signal provided by the third clock signal line CL3 and the timing of the signal provided by the fourth clock signal line CL4 are shown in FIG. 20.

In the embodiments of the present disclosure, as shown in FIG. 19, the third clock signal terminals YCK of the odd-numbered stages of gate driver circuit 10 are connected to the third clock signal line CL3, and the third clock signal terminals YCK of the even-numbered stages of gate driver circuit 10 are connected to the fourth clock signal line CL4.

As shown in FIG. 20, the signals provided by the third clock signal line CL3 and the fourth clock signal line CL4 have a phase difference, and both have a phase difference with each of the signal provided by the first clock signal line CL1 and the signal provided by the second clock signal line CL2.

The present disclosure provides a display panel. As shown in FIG. 21 that is a schematic diagram of a display panel provided by some embodiments of the present disclosure, the display panel 200 includes the above shift register 100, and the shift register 100 includes a plurality of cascaded gate driver circuits 10.

As shown in FIG. 21, the display panel 200 includes a plurality of pixel driver circuit rows 30, a plurality of first scan lines SPL, and a plurality of second scan lines SNL. The pixel driver circuit row 30 includes a plurality of pixel driver circuits 20. The pixel driver circuits 20 can be arranged according to the manner as shown in FIG. 3.

Exemplarily, the first scan line SPL is electrically connected to the first output terminal OUT1 of the gate driver circuit 10 to receive a first control signal. The second scan line SNL is electrically connected to the second output terminal OUT2 of the gate driver circuit 10 to receive a second control signal. Furthermore, the first scan line SPL is electrically connected to a gate of the first pixel transistor of the pixel driver circuit 20 shown in FIG. 3. The gate of the first pixel transistor is configured to receive the above first control signal. The first pixel transistor is electrically connected to the first electrode of the driver transistor Tm. The first pixel transistor includes a P-type transistor. For example, the first pixel transistor includes the data writing transistor T12 shown in FIG. 3, and the data writing transistor T12 is configured to receive the data signal.

The second scan line SNL is electrically connected to the gate of the second pixel transistor of the pixel driver circuit 20 shown in FIG. 3. The gate of the second pixel transistor is configured to receive the above second control signal. The second pixel transistor is electrically connected to the gate of the driver transistor Tm and includes an N-type transistor. For example, the second pixel transistor includes the threshold compensation transistor T13 or the gate reset transistor T11 shown in FIG. 3. The gate reset transistor T11 is configured to receive the first reset signal. The threshold compensation transistor T13 is electrically connected to the second electrode and the gate of the driver transistor Tm.

Exemplarily, in the embodiments of the present disclosure, the gate of the threshold compensation transistor T13 in the pixel driver circuit 20, that is, the third scan control terminal SN2, can be electrically connected to the second output terminal OUT2 of a current stage gate driver circuit 10, and the gate of the gate reset transistor T11 in the pixel driver circuit 20, that is, the first scan control terminal SN1, can be electrically connected to the second output terminal OUT2 of a previous stage gate driver circuit 10.

The gate of the data writing transistor T12 in the pixel driver circuit 20, i.e., the second scan control terminal SP, can be electrically connected to the first output terminal OUT1 of the current stage gate driver circuit 10.

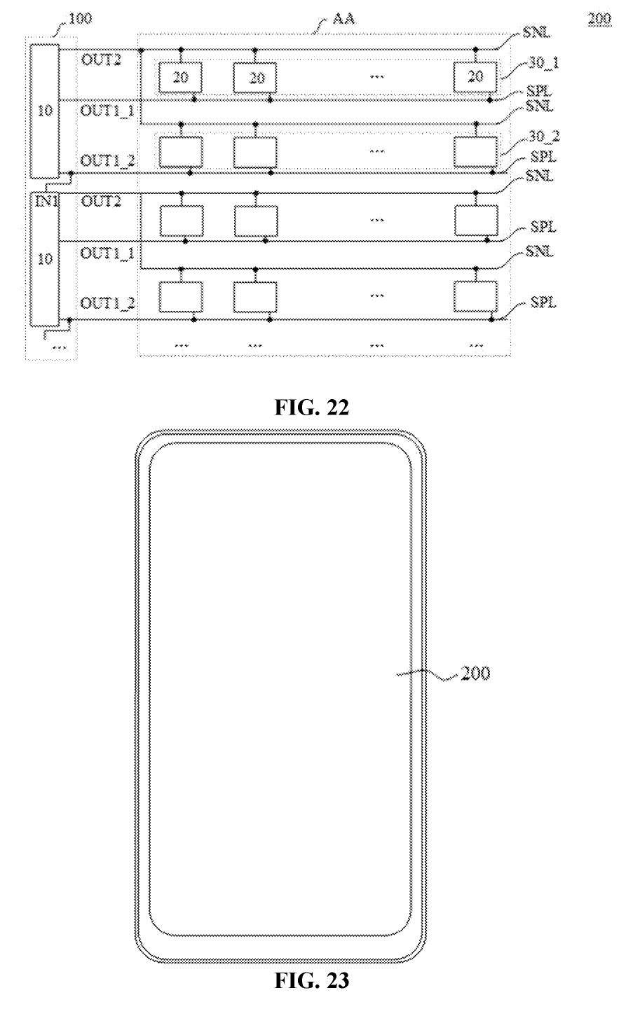

Optionally, in the case that the gate driver circuit 10 is configured to include two first output sub-circuits, two second output sub-circuits, and two first output terminals OUT1 in a manner shown in FIG. 15, as shown in FIG. 22 that is another schematic diagram of a display panel provided by some embodiments of the present disclosure, one stage gate driver circuit 10 can be electrically connected to two pixel driver circuit rows 30. Specifically, as shown in FIG. 22, the first output terminal OUT1_1 of the gate driver circuit 10 is electrically connected to the pixel driver circuit row 30_1, and the first output terminal OUT1_2 is electrically connected to the pixel driver circuit row 30_2. Furthermore, the pixel driver circuit row 30_1 and the pixel driver circuit row 30_2 can be electrically connected to the second output terminal OUT2 of a same stage gate driver circuit 10.

Optionally, as shown in FIG. 22, in the case that the gate driver circuit 10 is configured to include two first output sub-circuits, two second output sub-circuits, and two first output terminals OUT1 in a manner shown in FIG. 15, the first output terminal OUT1_2 of the current stage gate driver circuit 10 can be electrically connected to the first input signal terminal IN1 of the next stage gate driver circuit 10.

Some embodiments of the present disclosure provide a method for driving a gate driver circuit, which is configured to drive the above gate driver circuit 10. With reference to FIG. 1 and FIG. 2, the method for driving the gate driver circuit 10 includes the following steps:

during a first period t11, providing a first-level signal to the first input signal terminal IN1 and the first clock signal terminal CK, and providing a second-level signal to the second clock signal terminal XCK, so that the first output terminal OUT1 outputs the second-level signal, and the second output terminal OUT2 outputs the first-level signal; and

during a second period t12, providing the second-level signal to the first input signal terminal IN1 and the first clock signal terminal CK, and providing the first-level signal to the second clock signal terminal XCK, so that the first output terminal OUT1 outputs the first-level signal, and the second output terminal OUT2 outputs the second-level signal.

Based on the same inventive concept, some embodiments of the present disclosure provide a display device. As shown in FIG. 23 that is a schematic diagram of a display device provided in some embodiments of the present disclosure, the display device includes the aforementioned display panel 200. The specific structure of the display panel 200 has been described in detail in the aforementioned embodiments and will not be repeated herein. Of course, the display device shown in FIG. 23 is merely for illustrative purposes, and the display device can be any device with a display function, such as a mobile phone, a tablet computer, a laptop computer, an e-reader, a television, or a smartwatch, which is not limited in the embodiments of the present disclosure.

The above descriptions are only some embodiments of the present disclosure and are not intended to limit the present disclosure. Any modifications, equivalent substitutions, improvements, etc. made within the spirit and principles of the present disclosure should fall within the protection scope of the present disclosure.

What is claimed is:

1. A gate driver circuit, comprising:
a first driver circuit, which is connected to a first clock signal terminal, a first input signal terminal, and a first-level signal terminal, and which is configured to output a first node signal of a first node and a second node signal of a second node based on a signal of the first clock signal terminal, a signal of the first input signal terminal, and a signal of the first-level signal terminal;
a first output circuit comprising:
a first output sub-circuit configured to receive the first node signal and electrically connected to a second clock signal terminal and the first output terminal,
a second output sub-circuit configured to receive the second node signal and electrically connected to a second-level signal terminal and a first output terminal, and
the first output terminal configured to provide a first control signal; and
a second output circuit comprising:
a third output sub-circuit configured to receive the first node signal and electrically connected to the second-level signal terminal and the second output terminal,
a fourth output sub-circuit configured to receive a third node signal of a third node and electrically connected to the first-level signal terminal and a second output terminal, and
the second output terminal configured to provide a second control signal,
wherein an enable level of the first control signal at least partially overlaps with an enable level of the second control signal.

2. The gate driver circuit according to claim 1, further comprising:
a second driver circuit electrically connected to a second input signal terminal and the third node, the second input signal terminal being configured to provide a disable level to the third node signal when the second control signal is an enable level.

3. The gate driver circuit according to claim 2, wherein the second driver circuit comprises:
a first adjustment unit electrically connected to the third node and the second clock signal terminal and configured to control the third node signal based on a signal of the second clock signal terminal.

4. The gate driver circuit according to claim 3, wherein the first adjustment unit comprises:
a first capacitor comprising a first plate and a second plate which is electrically connected to the third node, and
a first transistor comprising a gate electrically connected to the third node, a first electrode electrically connected to the second clock signal terminal, and a second electrode electrically connected to the first plate of the first capacitor.

5. The gate driver circuit according to claim 4, wherein the second driver circuit further comprises:
a second adjustment unit electrically connected to the first node, the second-level signal terminal, and the first plate of the first capacitor.

6. The gate driver circuit according to claim 5, wherein the second adjustment unit comprises:
a second transistor comprising a gate electrically connected to the first node, and a first electrode and a second electrode that are electrically connected to the second-level signal terminal and the first plate of the first capacitor, respectively.

7. The gate driver circuit according to claim 3, wherein
the third node comprises a first sub-node and a second sub-node that are electrically connected to the second input signal terminal;
the second driver circuit further comprises an isolation unit electrically connected to the first sub-node and the second sub-node;
the first sub-node is electrically connected to the first adjustment unit; and
the fourth output sub-circuit is configured to receive a second sub-node signal of the second sub-node and electrically connected to the first-level signal terminal and the second output terminal.

8. The gate driver circuit according to claim 7, wherein the isolation unit comprises:
a third transistor comprising a gate and a first electrode that are electrically connected to the first sub-node, and a second electrode electrically connected to the second sub-node.

9. The gate driver circuit according to claim 3, wherein the second input signal terminal is electrically connected to the second node.

10. The gate driver circuit according to claim 9, wherein the second node is at a disable level when the first node is at an enable level.

11. The gate driver circuit according to claim 10, wherein the first driver circuit comprises:
a first writing unit electrically connected to the second node and comprising a first writing sub-unit and a second writing sub-unit,
the first writing sub-unit being configured to receive the first node signal and electrically connected to the first-level signal terminal and the second node, and
the second writing sub-unit being configured to receive the first node signal and electrically connected to the second-level signal terminal and the second node.

12. The gate driver circuit according to claim 11, wherein
the first writing sub-unit comprises a fourth transistor, which comprises a gate electrically connected to the first node, a first electrode electrically connected to the first-level signal terminal, and a second electrode electrically connected to the second node and the fourth transistor comprising an N-type transistor; and
the second writing sub-unit comprises a fifth transistor, which comprises a gate electrically connected to the first node, a first electrode electrically connected to the second-level signal terminal, and a second electrode electrically connected to the second node, and which comprises a P-type transistor.

13. The gate driver circuit according to claim 12, wherein the first writing sub-unit further comprises:
an auxiliary transistor, which comprises a gate electrically connected to the first-level signal terminal, a first electrode electrically connected to the first-level signal terminal, and a second electrode electrically connected to the fourth transistor, and which comprises a P-type transistor.

14. The gate driver circuit according to claim 10, wherein the first driver circuit comprises:
a second writing unit configured to receive the second node signal and electrically connected to the second-level signal terminal and the first node,
a third writing unit electrically connected to a third clock signal terminal and the first-level signal terminal, and configured to output the second node signal based on a signal of the third clock signal terminal and the signal of the first-level signal terminal, and
a fourth writing unit configured to receive the first node signal and electrically connected to the third clock signal terminal and the second node.

15. The gate driver circuit according to claim 14, wherein
the second writing unit comprises a sixth transistor, which comprises a gate electrically connected to the second node, a first electrode electrically connected to the second-level signal terminal, and a second electrode electrically connected to the first node;
the third writing unit comprises a seventh transistor, which comprises a gate electrically connected to the third clock signal terminal, a first electrode electrically connected to the first-level signal terminal, and a second electrode electrically connected to the second node; and
the fourth writing unit comprises an eighth transistor, which comprises a gate electrically connected to the first node, a first electrode electrically connected to the third clock signal terminal, and a second electrode electrically connected to the second node.

16. The gate driver circuit according to claim 14, wherein
the signal of the first clock signal terminal, the signal of the second clock signal terminal, and the signal of the third clock signal terminal are pulse signals with a same period, a pulse width of a low level of the pulse signals being smaller than or equal to a pulse width of a high level of the pulse signals; and
the signal of the first clock signal terminal, the signal of the second clock signal terminal, and the signal of the third clock signal terminal have phase differences.

17. The gate driver circuit according to claim 2, wherein the second driver circuit further comprises:
a first protection transistor electrically connected to the second input signal terminal and the third node, and comprising a gate electrically connected to the first-level signal terminal.

18. The gate driver circuit according to claim 1, wherein the first driver circuit further comprises:
a ninth writing unit electrically connected to the first clock signal terminal and the first input signal terminal, the ninth writing unit being configured to output the first node signal based on the signal of the first clock signal terminal and the signal of the first input signal terminal, and the ninth writing unit comprising a fourteenth transistor comprising a gate electrically connected to the first clock signal terminal, a first electrode electrically connected to the first input signal terminal, and a second electrode electrically connected to the first node.

19. The gate driver circuit according to claim 1, wherein
the first output sub-circuit comprises:
a first output transistor comprising a gate electrically connected to the first node, a first electrode electrically connected to the second clock signal terminal, and a second electrode electrically connected to the first output terminal, and
a second capacitor electrically connected to the first node and the first output terminal;
the second output sub-circuit comprises:
a second output transistor comprising a gate electrically connected to the second node, a first electrode electrically connected to the second-level signal terminal, and a second electrode electrically connected to the first output terminal, and
a third capacitor electrically connected to the second node and the second-level signal terminal;
the third output sub-circuit comprises:
a third output transistor comprising a gate electrically connected to the first node, a first electrode electrically connected to the second-level signal terminal, and a second electrode electrically connected to the second output terminal; and
the fourth output sub-circuit comprises:
a fourth output transistor comprising a gate electrically connected to the third node, a first electrode electrically connected to the first-level signal terminal, and a second electrode electrically connected to the second output terminal, and
a fourth capacitor electrically connected to the third node and the second output terminal.

20. A display panel, comprising:
a pixel driver circuit comprising:
a driver transistor,
a first pixel transistor electrically connected to a first electrode of the driver transistor and comprising a P-type transistor, and
a second pixel transistor electrically connected to a gate of the driver transistor and comprising an N-type transistor; and
a gate driver circuit comprising:
a first driver circuit, which is connected to a first clock signal terminal, a first input signal terminal, and a first-level signal terminal, and which is configured to output a first node signal of a first node and a second node signal of a second node based on a signal of the first clock signal terminal, a signal of the first input signal terminal, and a signal of the first-level signal terminal;
a first output circuit comprising:
a first output sub-circuit configured to receive the first node signal and electrically connected to a second clock signal terminal and the first output terminal,
a second output sub-circuit configured to receive the second node signal and electrically connected to a second-level signal terminal and a first output terminal, and
the first output terminal configured to provide a first control signal; and
a second output circuit comprising:
a third output sub-circuit configured to receive the first node signal and electrically connected to the second-level signal terminal and the second output terminal,
a fourth output sub-circuit configured to receive a third node signal of a third node and electrically connected to the first-level signal terminal and a second output terminal, and
the second output terminal configured to provide a second control signal;
an enable level of the first control signal at least partially overlaps with an enable level of the second control signal; and
a gate of the first pixel transistor is configured to receive the first control signal, and a gate of the second pixel transistor is configured to receive the second control signal.
